(19) United States
(12) Patent Application Publication
(10) Pub. No.: US 2023/0126832 A1
(43) Pub. Date: Apr. 27, 2023

(54) ENERGY ANALYSIS AND MANAGEMENT PLATFORM USING DISPARATE DATA SOURCES AND LAYERED FEEDBACK

(71) Applicant: Clemson University, Clemson, SC (US)

(72) Inventors: David Lawrence White, Clemson, SC (US); Snowil Lopes, Clemson, SC (US); Tim R. Howard, Clemson, SC (US)

(73) Assignee: Clemson University, Clemson, SC (US)

(21) Appl. No.: 17/972,349

(22) Filed: Oct. 24, 2022

Related U.S. Application Data
(60) Provisional application No. 63/271,172, filed on Oct. 24, 2021.

(51) Int. Cl. G06Q 10/0631; G07C 9/28

(52) U.S. Cl. CPC G06Q 10/06311; G07C 9/28

(57) ABSTRACT

A system for including a computer readable medium; data pipes a first emission source, second emission source, and remediation source, a remediation data pipe in communication with the server and a remediation source; a sensor; a facilities system in communications with a server; and, a set of computer readable instructions stored on the computer readable medium and configured to: receive first and second emission information, and remediation information, calculate an emission value, generate a facility action information according to a comparison of the enterprise emission value and a target emission value, and, transmit the facility action information to the facilities system wherein the facilities is configured to implement or reject an action represented by the facility action information.

### RELATED APPLICATIONS

This application is a non-provisional patent application and claims priority from U.S. Provisional Application 63/271,172 filed Oct. 24, 2021.

### BACKGROUND OF THE INVENTION

### 1) Field of the Invention

This system is directed to a system for the measurement, analysis, and management of the environmental impact according to disparate data collected from facilities to include buildings, enterprises, campuses and other sources. The system can include measurement, analysis and management of use, air quality, energy consumption, environmental impact, emissions, carbon footprint, remediation, and other information in real time. The system can include predictive analytics of air quality and energy holistically and enterprise wide through the use of layered feedback from the building level to other facilities and services.

### 2) Description of the Related Art

In modern society, there is an increased desire and need to reduce energy costs for building and campuses, including governmental, commercial, and academic. Energy efficiency, carbon footprint reduction, and improved indoor air quality are aspirational goals across the public and private sectors. The need for a system that can properly manage a building and campus is especially important to today's educational system. The air quality of the classroom environment can be suboptimal which can have an immensely negative impact on the cognitive skills and abilities of pupils. When air quality of a classroom is suboptimal, students cannot concentrate and/or are distracted from the work. Teachers that work in a suboptimal environment do not optimally support learning, and parents are distressed, troubled, or must take leave from work because children have to stay home, which can have significant socioeconomic implications. In one study, classroom air quality was approximated by measuring carbon dioxide (CO₂) concentrations and in few cases also outdoor air supply rates achieved by controlling the dedicated ventilation systems or by calculating them using the measured CO₂ levels (peak concentrations were used or the mass-balance model was fitted). A review of several studies in this area concluded that scores in math and English can be improved from 0.15% to 0.6% (median 0.375%) for each 1 L/s per person increase in classroom ventilation and that the percentage of students scoring satisfactorily or above (passing the tests) can increase by 2.7-2.9% for each 1 L/s per person higher classroom ventilation. Further, it was concluded that absence rates in relation to classroom ventilation show that 100 ppm lower concentration of CO₂ will reduce annual absence by 0.016% to 0.2% (median 0.07%) which corresponds to 0.03 to 0.4 days (median 0.14) per pupil per year with 200-day long school year.

The need to be able to properly control air quality and the indoor environment in school classrooms on learning outcomes cannot be stressed enough. A building management system should have the goal of optimizing air quality both internally to the building and in consideration of the environment. To achieve these goals, facility departments can play a significant role by leveraging vast data stores of utility data to enable improved decision-making concerning air quality as well as lower building energy use.

Unfortunately, much attention has been paid to energy use and monitoring, rather than air quality control and management or remediation. In fact, United States Federal Government has recognized the need to reduce the growth in demand for energy, and to conserve non-renewable energy resources without inhibiting beneficial economic growth. In one year, the United States Department of Energy reported that the total federal energy consumption for buildings was about 34% total energy used by the federal government and about 27% of the total cost. Therefore, reducing the energy used by buildings, campuses, and enterprises can have a meaningful impact toward reducing energy consumption leading to energy sustainability.

For air quality and energy use the first potential step is to understand the initial state of the structure and campus. This is advantageous so that any effect on the reduction of energy consumption can be measured. This first step of benchmarking the status allows for meaningful improvement in air quality, carbon emissions and energy consumption. Otherwise, there is not a quantitative method of determining the effect of actions taken to improve these areas.

One example of generating an energy use model is shown in U.S. Pat. No. 9,152,610. This reference discloses a system for generating an energy use model of a building that has a processing circuit for receiving building data that is a first type of building variable and for receiving additional building data correlated to the energy use of the building. However, this reference is limited in that it makes no mention of air quality, environmental impact, remediation, and the like.

United States Patent Application Publication 2017/0123391 includes a multifunctional thermostat that may be configured to measure any of a variety of air quality variables such as oxygen level, carbon dioxide level, carbon monoxide level, allergens, pollutants, smoke, etc.

One attempt to manage energy use is disclosed in U.S. Pat. No. 9,429,927 which is directed generally to integration of a building management system with smart grid components and data. This reference states that it may include an automated measurement and validation layer configured to measure energy use or track energy savings based on representations of the inputs stored in memory according to an international performance management and verification protocol. However, this reference does not show that the energy usage of the building can be determined based upon layered feedback so that an analysis of the building with disparate data sources can be made. While this patent discloses a demand response layer that may curtail energy use of the plurality of building subsystems based on the time-of-use pricing information it does not account for energy usage based upon a layered feedback approach.

Another attempt at building management is shown in U.S. Pat. No. 10,747,183 that is directed to a building management system (BMS) including a controller having an adaptive interaction manager and an agent manager. An I/O device is configured to receive an input from a user and communicate the input to the adaptive interaction manager. The agent manager is configured to determine if a software agent can perform the desired action, and to automatically transmit the existing software agent to one or more of the BMS field devices based on the agent manager determining the existing software agent can perform the desired action. The software agent is configured to automatically be installed in a processing circuit of the BMS field device to perform the required action. This reference fails to disclose the ability to use layered feedback for building management. U.S. Pat. No. 10,852,023 discloses a building maintenance system that includes learning but is limited to “leaning” the users voice for input into the system.

One attempt to manage air quality is disclosed in U.S. Pat. No. 10,509,377 which discloses an air quality monitoring and management system adapted to be mounted between an existing thermostat and a wall in which the thermostat was previously mounted, or directly at the HVAC system. This system requires a HVAC, UV lights source, fan, and air filtration system. It is also limited to a single building without any mention of a layered feedback system.

Of the limitations of these prior attempts at building management, there is not a provision for proper air quality management that holistically uses campus wide data. Nor is there a system that is well suited for data to be updated in real time. Under current systems, the data can take several hours preventing the effective and timely management of air quality, energy, and the like. Actions taken hours after measurements cannot effectively manage the building or campus.

Further, these prior efforts have been limited to individual structures. There is a need for a system that can measure energy and use from different components in different buildings of a campus, use disparate data sources to augment the data available and provide a layered feedback management system to efficiently manage energy use. United States Patent Application Publication 2014/0214222 discloses an energy management system that serves an arbitrary collection of loads via interfacing with related field devices and external information sources and some embodiments respond to events including one or more of pricing events, demand response events, and carbon reduction events by managing the loads and local generation. However, this patent application is limited to having a campus electric power distribution system configured to receive electric power from a utility power source via a utility interconnection that includes a utility revenue meter and to provide an energy manager for managing electrical loads interconnected with the campus' electric power infrastructure. It does not allow for the recording and management of energy campus wide to individual buildings without a campus electric power infrastructure.

One challenge in a system for proper air quality and energy analysis and management is that building utility information technologies are not designed for real-time data processing. For large campus and multitenant buildings that share energy district infrastructure, the ability to provide real-time data processing and resulting reports, action and predictions is limited if not entirely missing because the current energy systems are not designed to be integrated. Without this integration, quality data and modeling cannot be performed, and business decisions are negatively impacted. Such inability can increase the existing problem with poor air quality, especially in older buildings.

Current industry technologies do not factor in the requirements for advanced analytical systems that are needed for the system described herein. Further, current systems do not have dynamic functionality, real time data processing, or tool integration that has the ability to use multiple real-time data streams. It would be advantageous to have a system that allows for the receipt and processing of multiple real-time data from disparate sources and use this data in a layered feedback system for reporting, management, and prediction of building energy systems. It would also be advantageous for a system that can store utility data taken from disparate data sources and place them in an aggregated database which would then allow for web-based dashboards, data mining, and machine learning.

Further, “extract, transform and load” (ETL) frameworks, the process used by traditional systems, processes data in standalone applications and intermediary formats (e.g., within Python for the opensource ETL framework Bonobo or via the Power BI Report Server in the case of Microsoft Power BI). Existing ETL systems do not provide for the ability to manage the data volumes needed, do not provide for real-time analysis from disparate data sources, are not vendor agnostic, do not have the ability to actuate building controls based upon real-time layered feedback nor provide the tools for building and campus management that is required today.

An object of the present system is to provide a layered feedback system using real-time data to manage air quality and energy consumption in a timely manner.

It is another object of the present system to provide a campus wide system that can consider factors that improve as well as negatively affect air quality and energy consumption.

It is another object of the present system to use disparate data sources for the management of air quality and energy consumption.

### BRIEF SUMMARY OF THE INVENTION

The above objectives are accomplished by providing a system for actuating a facilities management system comprising: a server having a computer readable medium; a direct data pipe in communication with the server and a first emission source wherein the direct data pipe is configured to receive a first emission information from the first emission source representing a direct emission attributable to a facility; an indirect data pipe in communication with the server and a second emission source wherein the indirect data pipe is configured to receive a second emission information from the second emission source representing an indirect emission from a remote source; a remediation data pipe in communication with the server and a remediation source wherein the remediation data pipe is configured to receive a remediation information from the remediation source; a sensor in communications with the server; a facilities system in communications with the server; and, a set of computer readable instructions stored on the computer readable medium and configured to: receive the first emission information, the second emission information, and the remediation information, calculate an indirect emission value according to the second emission information and a remote source type, calculate an occupancy emission according to the sensor, calculate an enterprise emission value according to the first emission information, the indirect emission value, the occupancy emission and the remediation information, generate a facility action information according to a comparison of the enterprise emission value and a target emission value, and, transmit the facility action information to the facilities system wherein the facilities is configured to implement or reject an action represented by the facility action information.

The computerized system can be directed to controlling environmental conditions related to a structure comprising: a set of internal sensors in communications with an internal controller and associated with a first building configured to collect data; an internal data pipe representing data collected by the set of internal sensors; a set of external sensors in communications with an external controller and associated with a campus configured to collect data; an external data pipe representing data collected by the set of external sensors; a database in communications with the internal controller and the external controller and configured to receive and stores data from the internal data pipe and the external data pipe; and, a server having a set of computer readable instructions configured to normalize the data in the internal data pipes and the external data pipes, analyze the data from the data pipes, display a visualization of the data from the data pipes, determine a course of action according a set of rules associated with the internal data pipe and the external data pipe and transmit an action to the internal controller,

The analysis of the data from the data pipe includes determining the CO₂ in each room of the building. The computer readable instructions can be configured to transmit a fan on signal to the internal controller representing that air having a higher CO₂ content can be transmitted to an area with a lower CO₂ content. The computer readable instructions can be configured to transmit a fan on signal to the internal controller representing that air having a higher CO₂ content can be vented external to the building. The analysis of the data from the data pipe includes determining the temperature in each room of the building. The analysis of the data from the data pipe includes determining the occupancy in each room of the building. The set of sensors includes can include a wireless access point. The computer readable instructions can be configured to determine the number of users attached to a wireless access point. The computer readable instructions can be configured to determine occupancy according to the internal data pipe. The computer readable instructions can be configured to transmit a power off signal to the internal controller representing that the power can be turned off for a room anticipated not to be in use. The computer readable instructions can be configured to anticipate that a room will not to be in use according to a campus schedule.

The present system provides for existing data, including data from disparate sources, to be aggregated into a data store that improves utility management and can result in advantageous building and campus management. This system furthers the public institutions and private companies' goals of designing, implementing and operating building systems that further the sustainability goals. The present system provides for the designing, planning, and implementing of carbon reduction goals. The present system processes a real-time indoor air quality index to facilitate the identification of indoor air quality issues including with the use of a layered feedback system. This system also can provide for predictive modeling of energy demand, which also furthers the goals of effective building operations, and can include machine learning to identify future energy usage. This system's predictive features and functions for buildings and campus infrastructure future energy demands can improve energy planning and purchase. This system's holistic approach to campus monitoring and analytics can improve decision making on a building-by-building case. The system includes integrations modules that aggregates data across a heterogeneous sensor and communication network, realizing access to real-time data across multiple applications. This system includes a model for indoor air quality that can identify potential indoor air quality issues and even generate building maintenance tickets for air quality and other actual and predictive issues which can be managed by this system.

### BRIEF DESCRIPTION OF THE SEVERAL VIEWS OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 is a schematic of aspects of the system.

FIGS. 2A and 2B are schematics of aspects of the system.

FIG. 3 is a flowchart of aspects of the system.

FIG. 4 is a schematic of aspects of the system.

FIGS. 5A through 5J are schematics of aspects of the system.

FIGS. 6A through 6E are schematics of aspects of the system.

FIGS. 7A through 7C are schematics of aspects of the system.

FIGS. 8A and 8B are schematics of aspects of the system.

FIGS. 9A through 9C are schematics of aspects of the system.

FIG. 10 is a schematic of aspects of the system.

FIGS. 11A and 11 B are schematics of aspects of the system.

FIG. 12 is a schematic of aspects of the system.

FIG. 13 is a schematic of components of the system.

FIG. 14 is a flowchart of components of the system.

### DETAILED DESCRIPTION OF THE INVENTION

With reference to the drawings, the invention will now be described in more detail.

The present system includes a data platform that can integrate existing building, campus, facilities, and other data systems to improve analytic capabilities through the collection, aggregation, and interpretation of this data. The system can integrate with existing facility data systems to improve analytic capabilities through the collection, aggregation, and interpretation of the collected data. Examples of data that can be collected include power, temperature, water, indoor air quality, occupancy, and other building metrics. Further, external data used can include weather information, visitor management, facility functional information, CO₂ measurements, CO₂ remediation, environmental information, historical data, social activities, maintenance records, regulatory information, occupant demographics, work orders, and maintenance costs.

This system can use a campus utility data store and the internet of things (IoT) technologies to gather data and aggregate the data into a database solution that can be used to support web-based dashboards, data mining, and machine learning. The system can provide a real-time web dashboard displaying (providing visualization) information about electricity, chilled water, steam, CO₂, humidity, building occupancy, and building ticket information. The system can provide a holistic view of the campus or enterprise collectively or at the building level which can be used to analyze the overall performance as identify existing or anticipated issues. A user can view the metrics and can see a comparison of building performance displayed using a mapping interface. This system can provide for viewing facility tickets supporting management tasks such as sorting, deleting, and resolving building performance issues.

The system includes a novel data system that supports multiple applications. Data can be received and used in real-time that can exceed the ability to review millions of records (more than 200 million records in one analysis).

The system can include the use of Wireless Access Point (WAP) aggregation to estimate the occupancy by building in discrete intervals. Aggregated data can remove all personal information from the WAP data and only contains counts related to occupancy for individual in the building or on a campus or enterprise. The raw WAP data can be retrieved, aggregated, and deleted after processing has finished. The occupancy measurements can use three unique aggregations to predict occupancy in different intervals that indicate both how many users (including guest users) were in contact with a specific WAP or floor, and how many users used the building during each day.

This system can use monitor building occupancy in a high-resolution manner that previously provided. This system can measure occupancy across multiple spaces and floors and report building occupancy in real-time to dashboards, including web-based dashboards. The data used can be combined with other measures to optimized building systems such as lighting and HVAC systems, both for internal and external conditions.

Further, this system's novelty includes its ability to use a real-world facilities infrastructure that have specific components rather than the traditional approach of casting a wide net in an attempt to maximize data input formats. The present system minimizes the distance between disparate data sources and processes data without imposing an unnecessary load on critical infrastructure.

The present system uses a database server by orchestrating specific computer instructions for efficiently processing data. This system provides for custom aggregations, a management system, APIs for web development (e.g., Python), and an interface system to consume many data sources into multiple (even thousands) of pre-aggregated data streams (pipes).

The present system provides for partitioning of data received from the disparate data sources and can partition the data for subsequent use. Using pipes, data can be placed into a standard format that can include organization by building and building metric. This feature provides for overhead, increases information availability, and easier analysis that current systems thereby substantially improving the management of a building over existing technologies. Further, pipes can be cached intermittently by a caching module, thereby spreading the demand for large data processing requests among many small, lightweight queries. The system can receive data from disparate sources and flow through the integration module so that the data, regardless of its source, can be included in the associated pipe. For example, the system can apply integration module to a data source resulting in an aggregation pipe that can be cached the same manner as any other pipe. The system can use pipes definitions and can connect and update remote sources (such as pipes from Facilities' Oracle or other servers). Pipes may be chained together to create complex aggregations easily and efficiently. Pipes can be used to create layers and these layers can be used for feedback processing to actuate the building controls where the data was originally retrieved or received. The use of pipes allows for pipe actions to be applied to pipes. Pipe actions can share a standard set of arguments and may be triggered via the command-line interface or the administrative module. Access to the data that is delivered by pipes can be provided to third parties using application programming interfaces (API) where the API can be designed for scalability (e.g., high demand uses) which also preserving efficiency through caching pipes on storage media.

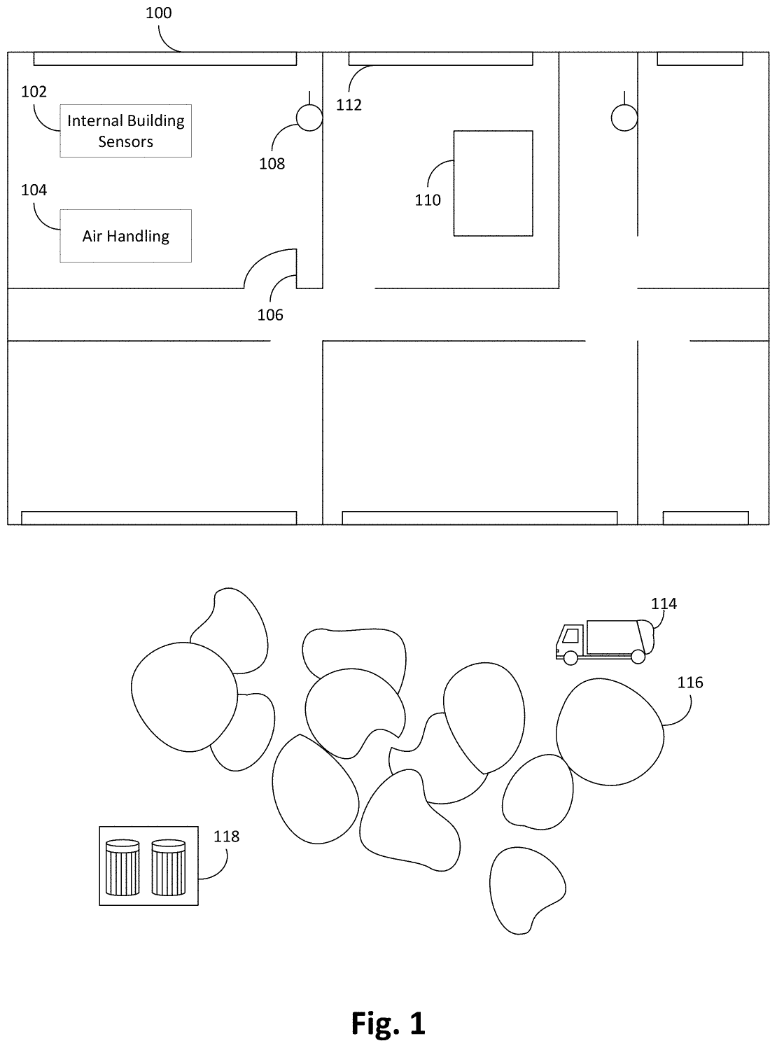

Referring to FIG. 1, data sources that can contribute to data pipes can be defined by function or location in building 100. Internal building sensors 102 can include data collection sensors and other components for determining temperature, humidity (moisture, Rh), air contents (e.g., O₂, CO₂, and other gases/elements), thermostat settings, UV, light, motion events, information network access (e.g., internal WAP), information network traffic, fixture activity, building status, energy usage, and the like. These data sources can be included in the direct data pipes and can represent data directed attributable to the building or facility. The building can include an air handling system 104 that can include an air conditioner, HVAC, fans, emissions sources and the like. Emission sources can include building equipment, transportation, fertilizers, animals, refrigerants, chemicals, stationary fuel, purchased electricity, commuting, food, paper purchases, travel, water used and processed, wastewater, composing, energy production, energy use, occupants, visitors, and the like.

A controller can include computer readable instructions that can receive data from any number of sensors, equipment, sources and air handlers in the building or campus. The information can be centralized in a data store and used for subsequent analysis and actions. The building can include automated shading system 106 that can be controlled locally or remotely. A room can include door 106 that can include a sensor that can detect an individual entering or exiting the room or building. The door can include an automatic opening and closing assembly with a sensor that can determine the status of the door (e.g., open, closed, opening, closing and the like). The building can include a wireless access point (internal WAP) 108 that can be configured to allow connectivity to a local area network or a wide area network (network). The network can be configured to identify devices connected to the WAP and associate the device with a user. A room can include equipment 110 such as scientific instruments that can include electron microscopes, lasers, centrifuges, refrigerated, heaters, hoods, incubators, spectrophotometers, refractometers, scales, sinks (e.g., water sources), timers, forges, optical sensors, sterilization devices, autoclaves, water baths, lathes, CMC machines, water jets, welders, generators, grinders, saws, engines, and the like. Some of this equipment can have a negative impact on air quality and can be large consumers of energy. These activities can result in direct and indirect emissions received through direct and indirect data pipes. The indirect emissions from purchased electricity, steam, heat, and chilled water can account for nearly 95% of emissions of universities reported in the Journal of the Air & Waste Management Association. This system can determine the energy usage of this equipment and approximate the CO₂ (and other emissions such as NOₓ HC, CO and PM) produced.

The computer readable instructions can be configured to transmit a shade down signal to the internal controller representing that the shades 112 for a room. The computer readable instructions can be configured to provide suggested modification to a schedule of use according to occupancy and actual use of the building. The computer readable instructions can be configured to calculate CO₂ for a campus according to the internal data pipe, the external data pipe and campus information. The campus information can include vehicle 114 use and emissions. The campus information can include CO₂ mitigation sources. The CO₂ mitigation sources can include natural areas including trees, shrubs, grass, and any combination shown as 116. The remediation efforts can include man-made systems such as direct aft capture 11 that can be actuated by the system as well as receive data through remediation data pipes. The computer readable instructions can include calculation for the CO₂ mitigation source by using methods including dry weight calculations.

The system can also gather data from external sensors that include temperature, humidity (moisture, Rh), air contents (e.g., O₂, CO₂, and other gases/elements), UV, light, motion events, information network access (e.g., external WAP), information network traffic, weather information, power production data sources, CO₂ mitigation objects such as direct air capture equipment, plants and trees 22 and other sources. Mitigation information can also be received, and determinations made from recycling efforts Sensors can be placed in and around CO₂ mitigation objects to measure the CO₂ at the sensor location and in other locations to assist with measuring mitigation effects. This data and data pipes provide for the system to compare gas levels that both increase undesirable gases as well as the mitigation of undesirable gases. The system can also gather data from one or more vehicles 24 which can be used to determine emissions from direct fossil fuel combustion as well as purchased energy in the case of electric vehicles. These vehicles can be direct sources such as commuting individuals or indirect such as vehicles that physically remove waste from a location.

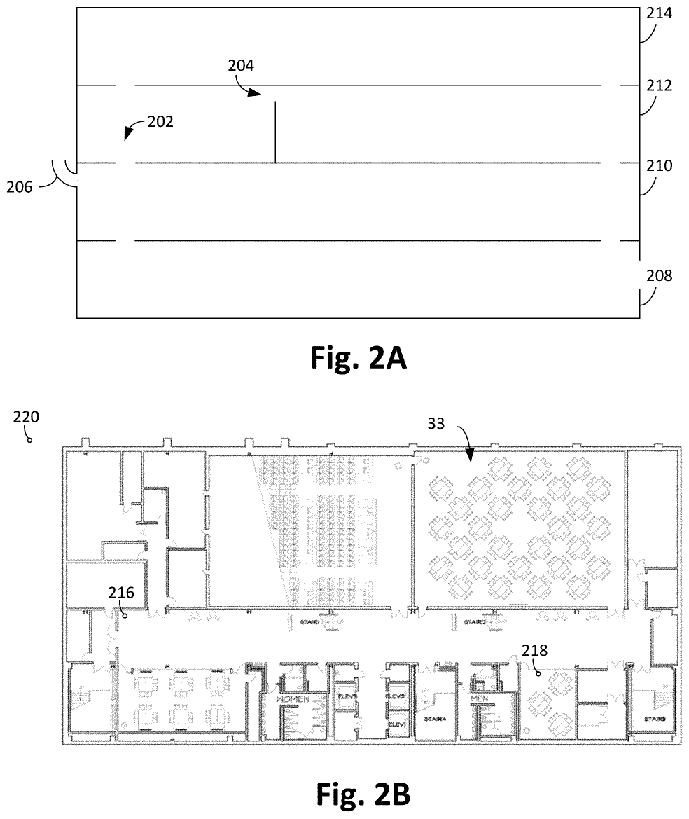

Referring to FIG. 2A, the building can include multiple rooms on multiple floors with fluid paths 202, 204 and 206 allowing fluid to flow between the rooms on a floor and between floors. Each floor or portion of each floor can include sensors and equipment that can provide data for one or more data pipes. For example, a building can have a first floor 208, second floor 210, third floor 212 and fourth floor 214. Sensors can be placed on each floor or portion thereof and measure emissions, equipment usage, occupancy, activity (e.g., food consumed, physical exercise of occupants, water used and the like. A facilities system can include an air handler controller that can actuate the air handlers to move air from room to room, floor to floor, internal to outside, outside to internal and any combination.

Referring to FIG. 2B, and in an exemplary embodiment, a first CO₂ sensor 216 can be disposed on one side of the building and a second CO₂ sensor 218 can be disposed on the second side of the building. When the data is received by the computer readable instructions from these sensors, the data can include date and time so that the CO₂ levels can be measured during a period of time. These sensors can represent direct emission information. The system also allows for the CO₂ levels, in this example, to be overlayed with occupancy, temperature, use and other data so that a determination can be made on how to manage CO₂ levels. The system can also receive external information from sensor 220 that can include measurement of passing vehicle traffic, waste removed and other data. This can represent indirect sources of emission information. The system can determine an indirect emission value according to the indirect emission information and the remove source type. For example, a passing vehicle can be determined to generate XX ppm CO₂, or other emissions. In one embodiment, sensor 220 can receive an image from the vehicle, determine the make and model of the vehicle and assign a value of CO₂ emission to that vehicle. In one embodiment, the system can determine that the vehicle is a vehicle class so that an approximation of CO₂ production can be assigned to the vehicle. Typically, a vehicle in a class with a smaller engine and more modern manufacture will have a lower emission value.

A sensor 216 can measure CO₂ at its location and in this example can report that the level is 1000 ppm, an acceptable level for an educational building. Sensor 218 can be placed in a classroom and can measure the CO₂ levels. In one example, levels can be 1000 ppm in the morning (e.g., prior occupancy) and subsequently, due to the occupancy of the classroom, rise to a value of 1500 ppm, which exceeds the acceptable levels. In one embodiment, the system can determine the emission of a portion of the building, such as the location of sensor 216 and use the occupancy of another location 222, lacking a sensor, and approximate the emission of levels of the area 222. For example, sensor 216 can measure the CO₂ through sensor as well as determine the occupancy. The occupancy of the CO₂ at location 222 can be approximated by determining the occupancy at location 222 and raising or lower the predictive levels according to the differences in the occupancy between the location of sensor 216 and location 222.

In one embodiment, the system can read unacceptable air quality at sensor 216 and determine that a pattern of rising CO₂ in that area reaches unacceptable levels when the occupancy is above a predetermined level such as O₁ which can represent the occupancy at a certain time. The system can then generate information that provide suggestions such as modifications to a scheduling system to distribute occupancy over a wider area so that there is less occupancy at any given time in an effort to reduce the emission at certain times and have then remain under acceptable levels. Further, the system can show and predict energy and therefore costs saving were such modifications to the schedule be implemented. For example, when the occupancy is at O₁ the energy used can be E₁. If O₁ is at a time where there is peak energy costs, there is a desire to reduce the amount of energy to off peak times. Therefore, suggesting that O₁ is reduced and provide suggested rescheduling of occupancies to O₂ can reduce energy use and costs. The system can also receive information concerning fuel types that can be included in the data pipes. For example, the system can determine the make and model of a vehicle and determine its fuel source, or can receive information about the vehicle (e.g., identification of the vehicle and associated fuel type or assign certain fuel types to activities such as water removal). By way of example, the system determine that a waste vehicle is in operation and that the waste removal vehicle is a diesel vehicle. The fuel type can determine the CO₂ emissions in one embodiment. In one determination, a diesel engine emits about thirteen percent more by mass per liter of fuel burned than a vehicle fueled with gasoline so that the system can propose using certain vehicles at certain times, changing fuel types and scheduling vehicles so that the overall emissions of the enterprise are reduced. The system can also associate fuel type with the use of electricity. For example, the system can receive information about the fuel type for electricity used during certain times. Nuclear power can be used for off-peak power and can be XX% of the energy that is generated at off-peak power. Because nuclear power uses about 12 and 14 grams of CO₂ equivalent per kWh of electricity and coal, produces more than seventy times as much CO₂ equivalent per kWh of electricity, the system can display the emission that are being used at electrical use for fuel type and determine the CO₂ that results from such energy use. The system can also propose modifications to electrical usage and associate these modifications with fuel type so that overall emission can be reduced. For example, it may be that the peak power is generated using mostly coal while off-peak power is produced with more nuclear. The system can determine the fuel type and display and propose modification for overall reduction in emissions due to the energy usage.

Further, modifications to the scheduling system can result in less strain on the energy system associated with the building, facility, or enterprise. When there are increase emission levels associated with a class schedule the association allows the system to anticipate potentially rising levels in one area of the building with similar configurations including area, disposition near windows and vents, number of occupants, and the like. Therefore, the system can learn from existing sensors data and apply that information to anticipate non-measured areas. The system can also use schedule information, occupancy information, including work order for facilities maintenance, and provide for predictive increase in undesirable emissions that will occur when occupancy and activity increases.

In one embodiment, the system and response to unacceptable levers of emission or air quality, the system can increase air flow to the area containing the second sensor to reduce or dilute CO₂. In this embodiment, the system can generate facility action information that can suggest or propose actions to be taken by the facilities system which can affect emission. For example, the system can propose that a modification to the operational setting of the air handler be made so that the next time the class is scheduled to be occupied, the system can increase air flow in anticipation of rising CO₂.

The system can also determine that the projected increase in CO₂, in this example, raises the overall CO₂ for the enterprise by about 500 ppm when the classroom is occupied. Therefore, the system can implement remediation measures to offset the increase in CO₂ For example, the system can implement measures that can include reducing the power delivered to a particular power load for some period of time to reduce, implement CO₂ capture components such as absorption (e.g., solvents, sorbents, membranes and electrochemical) so that the overall CO₂ is not increased. The system can also forecast the remediation efforts needed.

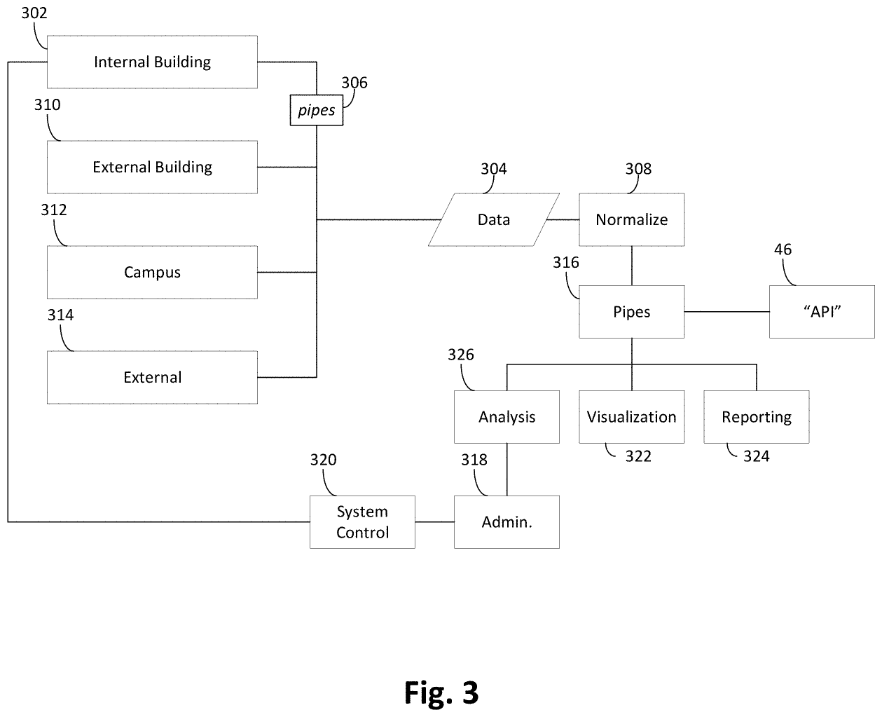

Referring to FIG. 3, the system is shown in a flow chart that is used for those skilled in the art to understand the structure and function of the system. A combination of specialized hardware and computer readable instructions provides the structure and function described herein. Building 302 can include internal components that can include controllers, sensors, actuators, equipment, and other devices as described herein. The components can each generate data and can be included in a data pipe can be transmitted to a local storage associated with the building as well as an external data store 304. The data can be transmitted to the data store from each data source, can be aggregated into a pipe 306 or both. The data store can be an immutable ledger such as a block chain. The data store 304 can be in communications with a local or remote server that can include computer readable instructions. The server computer readable instructions can receive the data and format the data into pipes which can use a normalization module 308 to normalization of the data from the building. The data can include the data source type that can be used to determine emissions.

The system can also receive data from external sources 310 such as CO₂ sensors disposed outside the building, vehicle information and other data points that are outside the building. The system can receive data from campus information sources 312 that can include class schedules, visitor information, event information (e.g., sporting events, social events, educational events), activity information, individual traffic, population density, and other information. For example, a sporting event can draw a large population with vehicles, generators and create organic CO₂ generations. The system can receive external data 314 that can include weather data, environmental data, community data and the like. Community data can include data such as CO₂ levels of the surrounding community which impact the CO₂ levels of a campus.

These data sources can be gathered in the data store 304, normalized and pipes 316 create that can deliver the data from these multiple sources to an analytical module 326. The analytic system can include computer readable instructions that can overlay the data from various pipes and be configured to determine the air quality of a building down to the certain room. If the air quality is not optimal (e.g., the CO₂ is too high), the system (administration module 318) can be in communications with an air handler controller 320 and send information that actuate the air handle to vent air from the outside into the room or can send a proposed action for the facility system to take to vent air from the room. If the outside air is not desirable to be moved into the building, according to outside data and air analysis, air from one room can be moved to another room to, for example, dilute the CO₂ in the target room thereby improving the air quality in the target room. The air handler can also be actuated to move air from floor to floor to improve the air quality. For example, if the CO₂ is a target room is 1000 ppm and the CO₂ of an adjacent room in 900 ppm, the air between the rooms can be blended, especially if the adjacent room is unoccupied that can result is a more advantageous CO₂ in the target room without unnecessarily undermining the air quality of the adjacent room. By using the disparate data sources and organizing them into pipes the initial building can have its building management systems actuated according to information from the various data layers in a feedback system. A portion of the data from the initial building is used to analyze air quality and energy use, combined with dissociate sources, analyzed and action is taken back to the initial building in the layered feedback system.

When receiving data, the system can create a first pipe 306 that can be an aggregation and/or normalization of the data from one or more data sources in a subgroup of a campus of enterprise, for example the building. For example, the occupancy can be determined by receiving data from internal wireless access points, door sensors, proximity sensors and the like. This data can be overlayed with anticipated occupancy for subsequent times during the day and the system control for the building sent information allowing it to adjust the building systems accordingly. For examples, for the last class of the day in a room, floor or building, the system can reduce the power consumption of the building minutes or hours prior to the end of the class so that unnecessary energy is used for air handles and air conditioning when the building in unoccupied.

The first pipes from the data sources can be aggregated and normalized into a second pipe 314. The first pipe and second pipe can include access points (e.g., API) 52 allowing third parties to receive the data in the pipe. The system can provide meaningful visualization 322 and reporting 324 from the system that can be used for decision making and predictive analysis. For example, over time a history of the air quality and the history of the building can be recorded and used to predict high energy usage and detrimental factors to air quality. This information can be used to minimize the detrimental effect of occupancy, building use, and equipment when scheduling future events. When determining class schedules for the future, such as the next semester, the system can provide information and guidance concerning the impact of a schedule on the air quality and energy consumption. Spreading out classes and facility use, and equipment use can flatten the negative affect on the use and the energy consumption. This system can provide the information to assist with this task.

The system can also determine the net effect of air quality considering internal and external factors. The system can receive air quality information (e.g., CO₂ levels) from a building and its use, occupancy, and equipment. This information can be used to reduce the amount of CO₂ emissions both directly and indirectly through the management of energy consumption associated with the building, The same information and management can be used with a second building so that the net effect of the two buildings on CO₂ emissions can be determined. This information can be combined with external air quality factors such as enterprise and campus events (e.g., sporting, and social activities), vehicles use and remediation efforts. For example, the CO₂ levels can be managed to reduce the CO₂ emission that result from direct and indirect sources associated with the campus below that of remediation efforts. In one embodiment, the system can determine the CO₂ absorption of the land (especially plants) around the building and on campus. For example, the following can be used to determine the amount of CO₂ that a certain species of tree the weight of the tree is determined.

Where D<11:W=0.25*D²* H (1)

Where D>=11:W=0.15*D²*H (2)

Where W=above-ground weight of the tree in pounds, D=diameter of the trunk in inches and H=height of the tree in feet. It understood that the species of the tree can determine the value of the coefficient C so that the equation can be as follows:

W=C*D²*H (3)

A determination of the dry weight of a tree would be 72.5% of Wand CO₂ is about 50% of the weight of a tree so that the amount of CO₂ that is absorbed per year by the tree can be determined measuring the tree year to year. Receiving this information from the information directed the enterprise or campus, the system can determine and manage the CO₂ to net-zero or even negative CO₂ emissions.

In one embodiment, the system receives data from the various pipes in real-time and actuates the building controller according to the data received. For example, an occupancy data pipe can provide information that the building has been 75% occupied for certain periods of times during the day. Therefore, the data can show that were the building activities consolidated on one or two floors and a third floor remains empty, efficiency can be achieved in the use of energy and the detrimental impact on air quality.

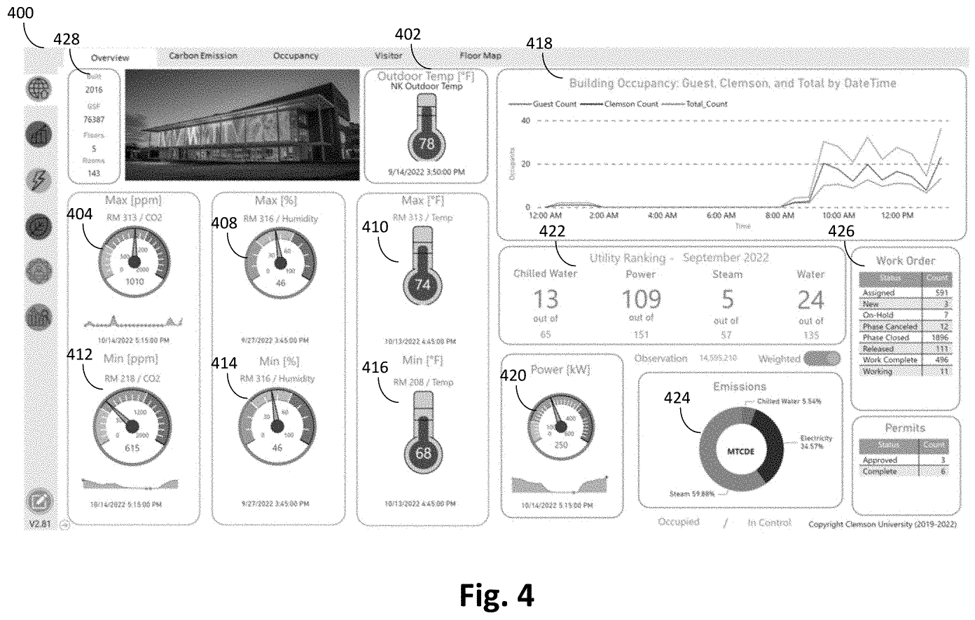

Referring to FIG. 4, an example of the information that the system is able to receive, process, analyze and manage is shown. The system can include data received from and be in communications with a variety of sensors from a single room to an enterprise campus. One example of an output from the system can include a dashboard 400 that can display information received from sensors wherein each display includes information that can be received from a sensor included in the system. The sensors and information received, analyzed, and managed can include outdoor temperature 402, maximum CO₂ for a specific portion of a facility, such as a room shown at 404, maximum humidity 408, maximum indoor temperature 410, minimum CO₂ level 412, minimum humidity 414, minimum temperature 416, occupancy over time 418, power consumption 420, ranking 422, emissions 424, and work orders 426. The system can also displace facility information 428 as well as occupancy type.

The system can include an analysis of the carbon emissions over a period of time, shown yearly in this example, from the sensor level to the enterprise campus level. The system can display results from computer readable instructions that can calculate effects to air quality and air content such as carbon emissions for a period of time such as the past year. The system can also determine the carbon emissions and contribution to CO₂ according to the facilities and utilities associated with a building or campus. For example, the system can determine the amount of carbon that is created or is a result of the creation of use of chilled water, electricity, steam, and water individually or in the aggregate. The system can determine and display the information by scope which can be associated with emission type as discussed by scope below.

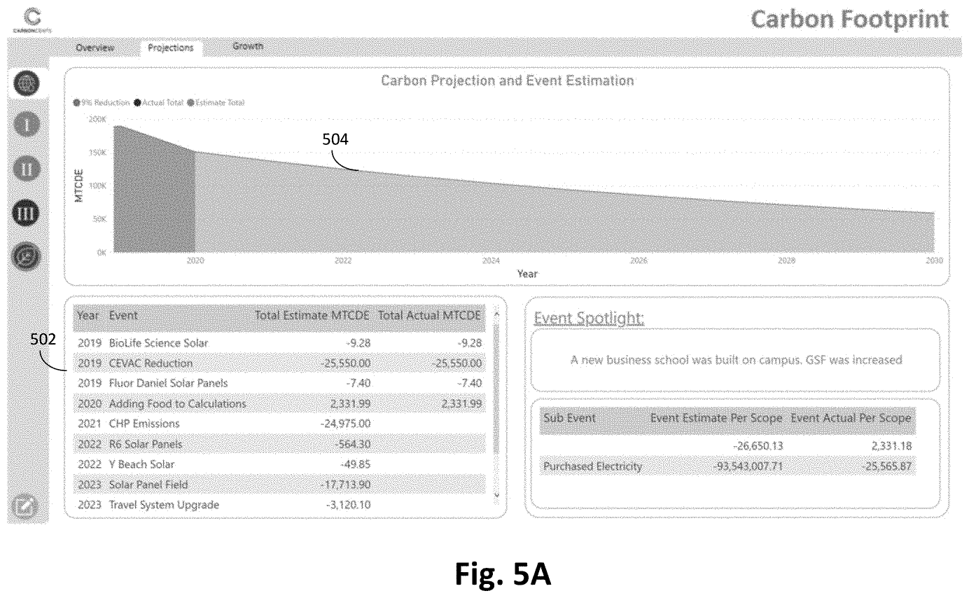

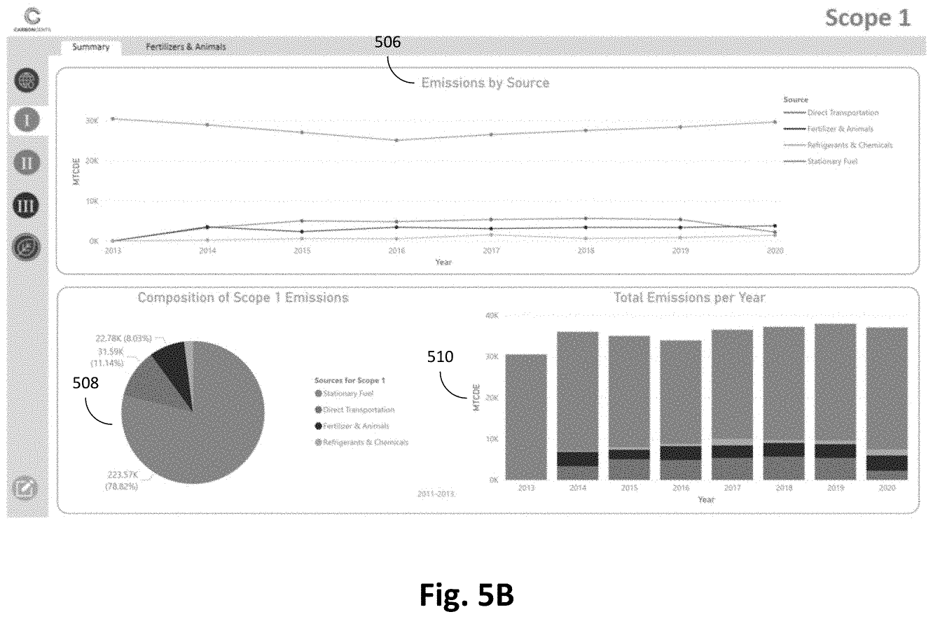

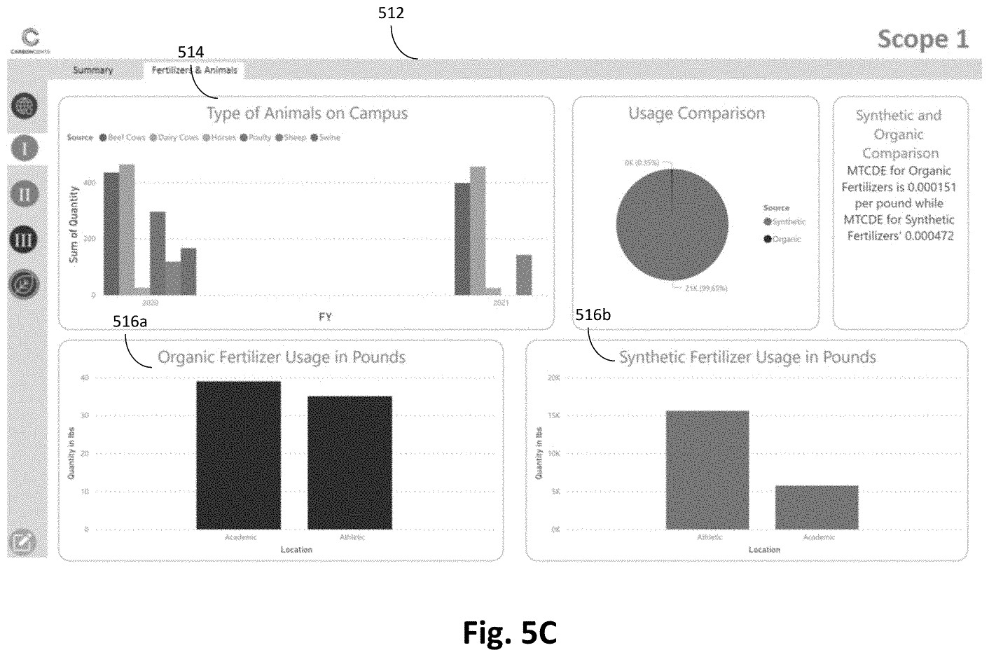

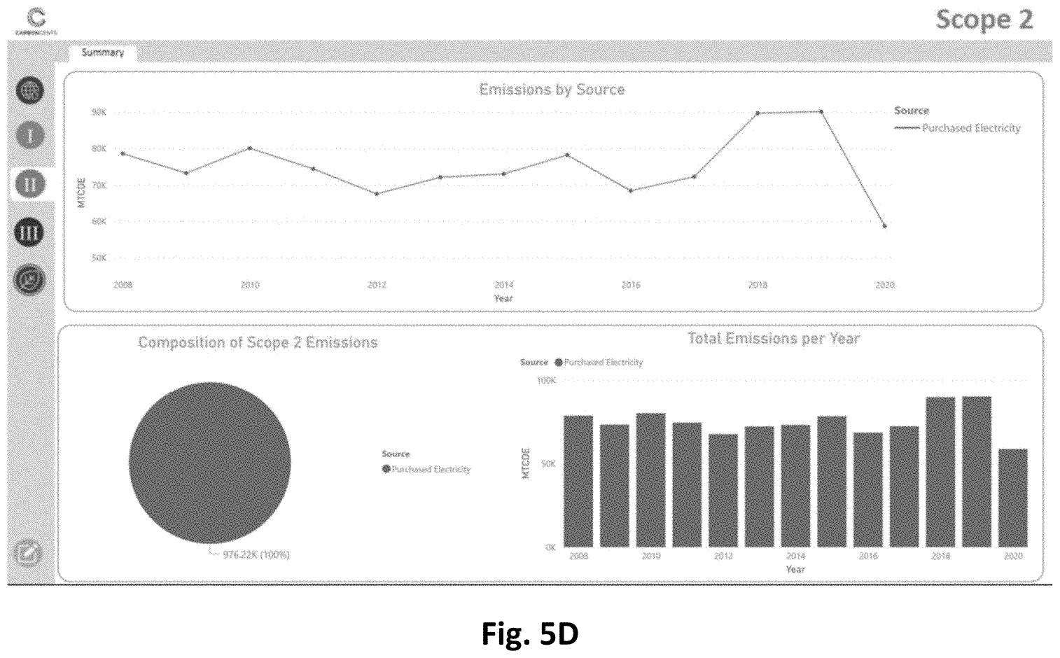

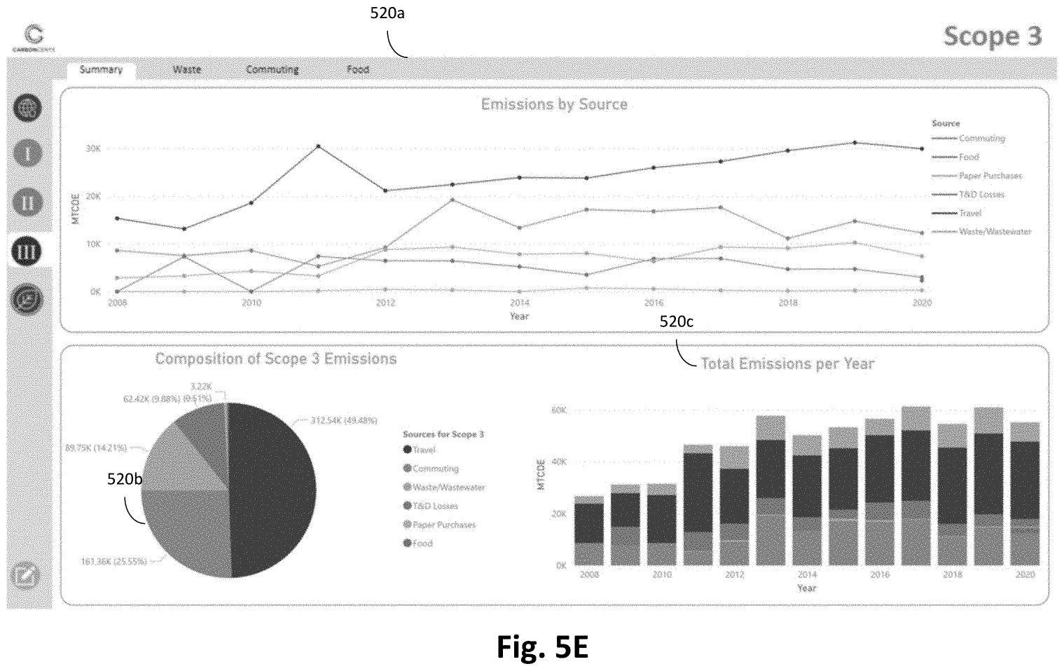

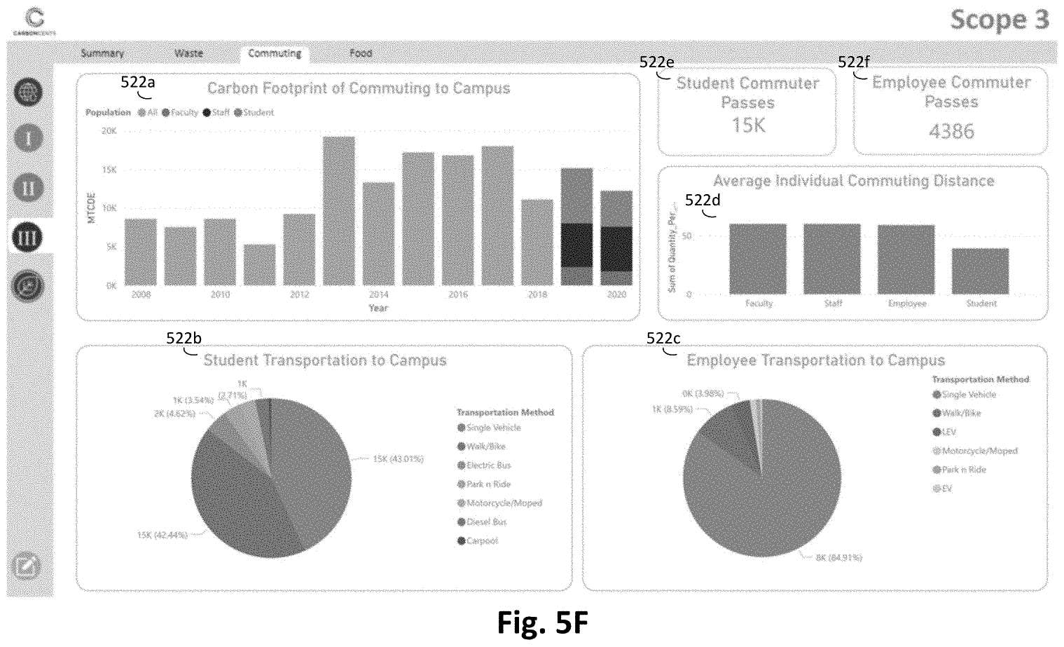

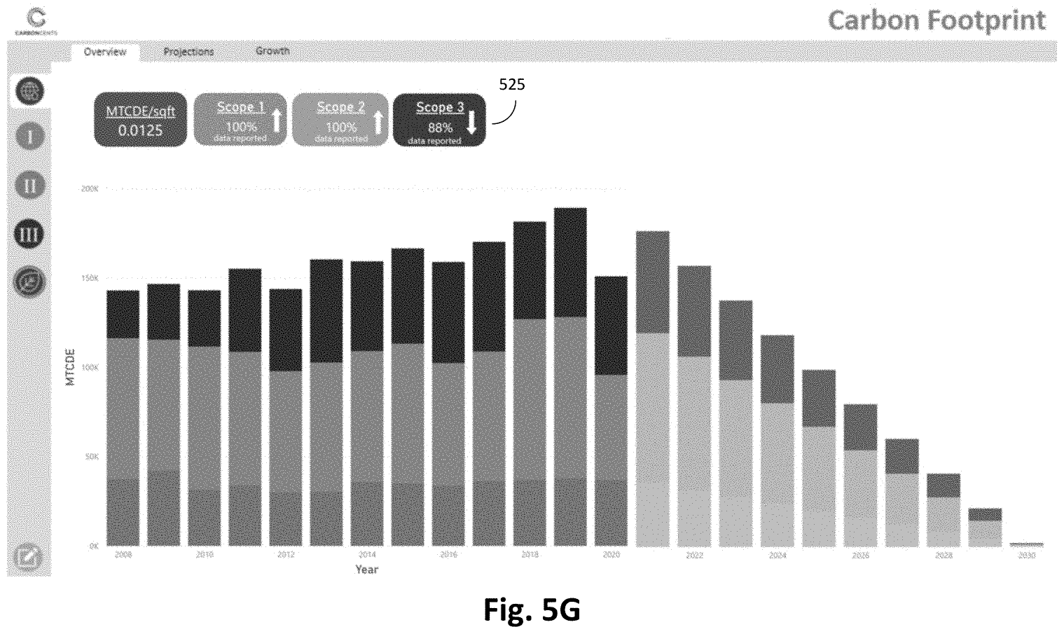

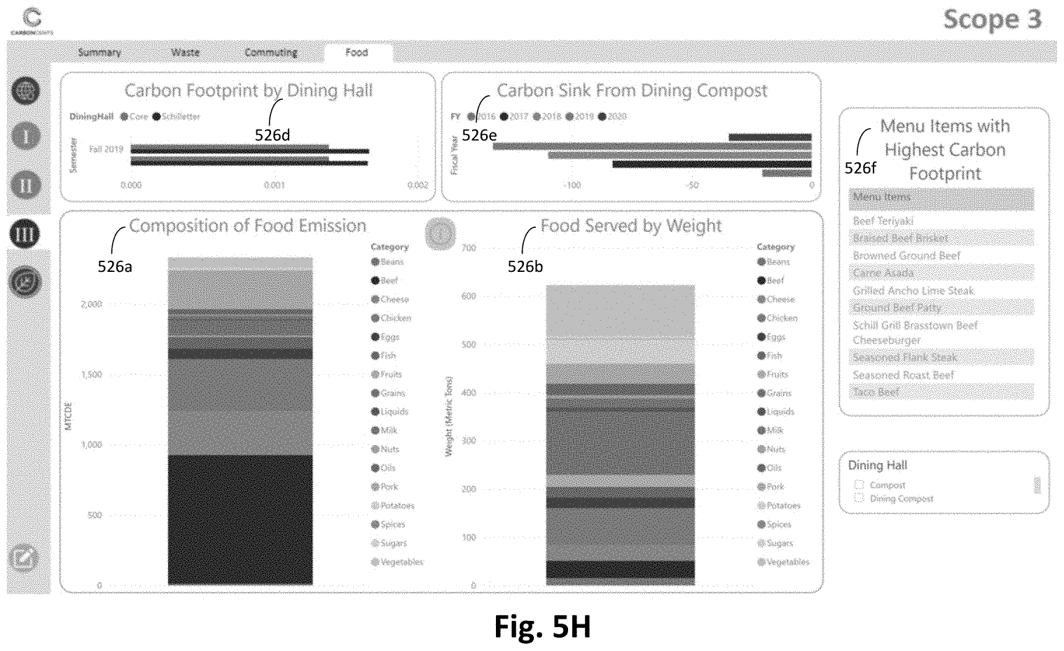

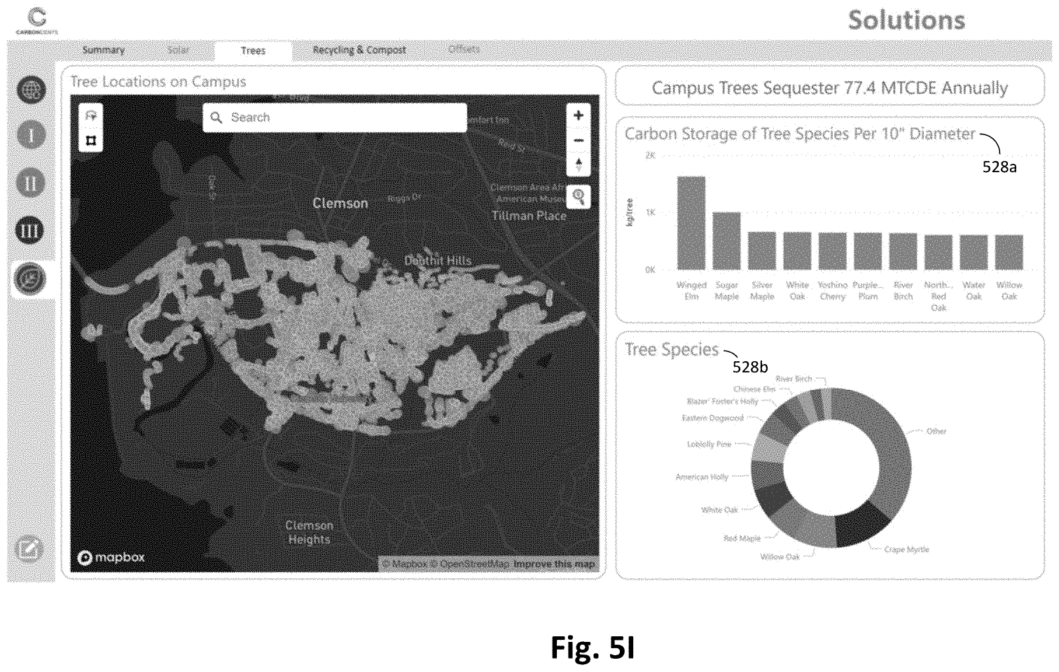

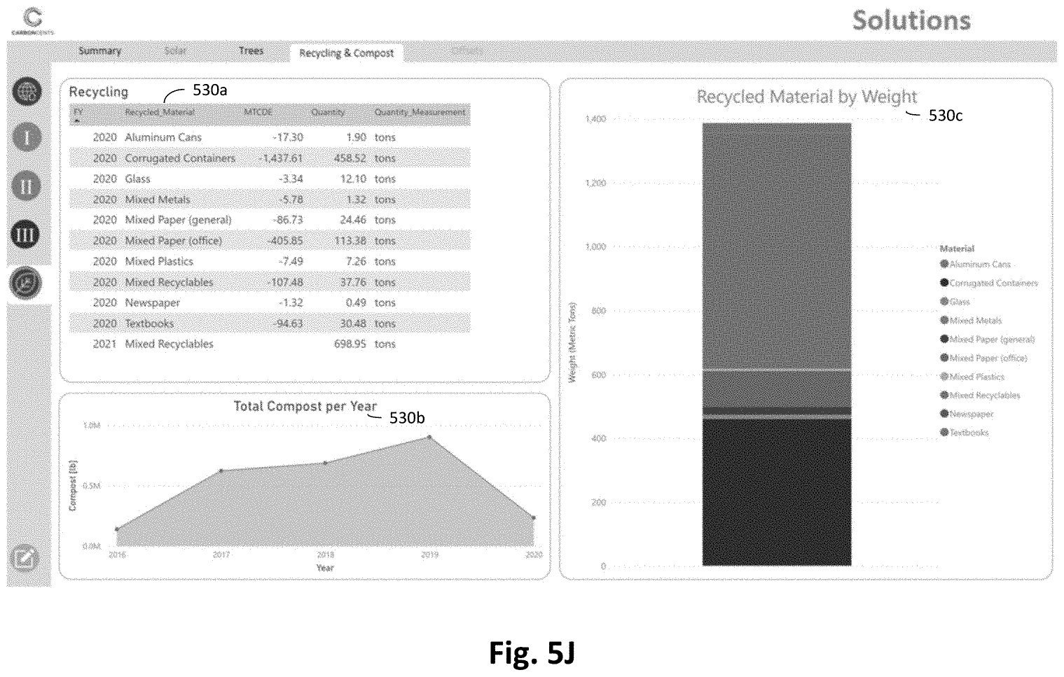

Referring to FIG. 5A, the system allows for emission and remediation to be projected according to the action that is taken or can be taken for reduction of emissions. The action or event 502 can be shown and can represent actions that were taken historically, actions that are currently being taken and action that may be taken in the future. The dissection of components (e.g., buildings) 508 of the enterprise by selection which can results in the aggregate and the display of data for the components elected. A selection for categories 510 can be made as well. The system can receive, determine, and predict the metric tons of carbon dioxide equivalent (MTCDE) from the various data pipes and data sources can display the results graphically at 504.

In this example, a display can illustrate the data, analysis processing and of the system for predictive information and planning information for the reduction and even elimination of carbon emissions (e.g., a zero-carbon footprint plans). The system can determine the carbon usage of the enterprise, reduction in carbon emissions according to remediation events (e.g., installation of solar energy system or other noncarbon-based energy systems) and determine the reduction of the carbon footprint of the enterprise were proposed action taken and show the enterprise emission value as compared to a target emission value. Therefore, the users of the system can determine what actions to take, changes to make and evaluate remedial system, including costs, and compare these to the effect of carbon reduction.

Referring to FIG. 5B, the system can receive data pipes that are emission by source as display the information graphically at 506. The information can be received, analyzed, and categorized by scope type with scope 1 including emission sources such as direct transportation, fertilizer, animals, refrigerants, chemicals, stationary fuel and any combination. The computer readable instructions can compare and display the various emissions sources at 508 and can aggregate these by a period of time as shown as 510.

Referring to FIG. 5C, the system can receive, analyze, and display information from a specific emission source. In the example shown, the emission source can be associated with a specific source or classification of source. In this example, the source can be fertilizers and animals that can be associated with agriculture operations or education (e.g., commercial operations, public operations, university and the like). Screen 512 can display the animals on campus 514 and usage by activity source 516a and 516b.

Referring to FIG. 5D, the system can receive data about, analyze, report and create actions from data including data that is shown in this example as scope 2 data which includes purchased electricity. Purchased electricity can be direct data which is electricity directly related to the operation of the facility or can be data associated with the purchase data (e.g., fuel type for electrical generator) which can be indirect. The display 518a can show emission by source, composition of the emission source 518b and yearly emissions 518c. FIG. 5E illustrates emission sources that can be included in another scope where the display 520a can show emission by source, composition of the emission source 520b and yearly emissions 520c. In this example, the emissions sources can be indirect sources such as vehicle emission related to commuting, food consumption, paper purchased, energy transmission and distribution losses (T&D losses), travel, and water and wastewater production.

FIG. 5F illustrate a specific emission source that can be included as an indirect source and can be included in the Scope 3 classification. In this example, commuting data can be captured, analyzed, displayed, and used for predictive analytics as well as to generate recommendations and to control other systems. Emissions can be for each individual type such as faculty staff and students as shown by 522a, composition by transportation method 522b and 522c, average commuting distance 522d and the number of commuting passes 522e and 522f. In one embodiment, the system can provide suggestion for location and construction of new student housing, classrooms and parking so that the commuting distances can be designed to beneficial impact emission such as determining the emission for one configuration in comparison to another configuration. Therefore, when planning future facilities, the plan can include emission impact.

In one embodiment, the emission sources can be classified according to industry standards. Scope 1 emissions can be those that are direct emissions from users owned and controlled resources. For example, fertilizer used, chemicals used, station fuel and the like. Stationary fuel typically includes combustion sources of solid, liquid, or gaseous fuel and can be used for producing electricity, generating steam, or providing useful heat or energy for industrial, commercial, or institutional use. Stationary fuel can also include emission sources associated with reducing the volume of waste by removing combustible matter. Scope 2 can include emissions released into the atmosphere as a direct result of a set of activities, at a firm level such as chiller water production. It is divided into four categories: stationary combustion (e.g., fuels, heating sources). Scope 3 can include indirect emissions covering all non-direct sources that come from peripheral activities related to the organization. Scope 3 emissions can be those that result from goods and services delivered through an outside provider, as well as waste disposal, investments, product distribution, franchises, leased assets, emission from commuting and employee travel. The system allows for the analysis and display of these difference scopes for ease of analysis and reporting purposes. The system can receive data, analyze, process, display and provide recommendation and actions for facilities system according to the scopes of the emission sources as shown in FIG. 5G. Each scope 525 can be displayed in aggregate or individually. The impact of actions or omission can be shown from data reported or in the event that proposed modifications or actions are implemented into facility systems and remediation systems.

FIG. 5H illustrate the system's ability to received, analyze, report, display and use for predictive analysis, recommendations, and generation of direct and indirect system actions (e.g., directly controlling a facility system or transmitting a recommendation action to a facility system) for an emission source such as food. The system can determine emissions by composition 526a, weight 526b and location 526d and 526e. The information can be analyzed and displayed by year. The system can receive information concerning prospective activities such as the proposed menu for an eating facility. Using emission information and historical consumption information, the system can determine emissions (e.g., CO₂ emissions) associated with a specific menu and menu items 526f. The system can determine from a menu and historical data which food item is likely to be consumed and in what portion. The system can then provide recommendations for menu-modifications so that emissions can be lowered for a given proposed menu. Receiving information such as CO₂ associated with particular items that can be used for the reporting, predictive and proposed recommendations functions of the system for each emission source, including food preparation and consumption.

Referring to FIG. 51, the image illustrates the ability of the system to receive, analyze, process, aggregate and used the data from remediation system that can include natural system such as landscaping (e.g., trees and shrubs) as well as man-made system such as direct air capture, recycling, solar energy production, clean energy production, offset and the like. In one embodiment, the system can determine emission remediation according to the remediation type such as trees and even specific tree type as shown as 528a. The system can also determine the composition of the remediation source by type as shown as 528b. The location and the remediation impart can be shown graphically as well. This information can be used for predictive purposes so that the system can determine the overall emission if an emission source were placed at or near a remediation source. Further, the system can determine a preferred location for a future emission source. For example, a portion of land for a new building that is near a large grove of trees may be more desirable as the number of tree, density of tree and the tree type can have an increased remediation effect compared to other location and can more efficiently offset the emission produced by the prospective building. The system can also determine recommended locations for additional remediation sources such as locations where additional trees and tree types can be planted. Referring to FIG. 5J, the impact of recycling can be received, analyzed, processed, displayed and used for prediction and generating recommendation for other remediation solutions, such as recycling, as well. The recycling type 530a can show the effects on the overall emission (e.g., CO₂) and can be used by the system to show the impact of increasing or decreasing such activities. The information can be received (e.g., through data pipes since the information for material may not be from the same source), can be used for display, predictions and recommendation and can be by year 530 and weight 530c for each material, in this example.

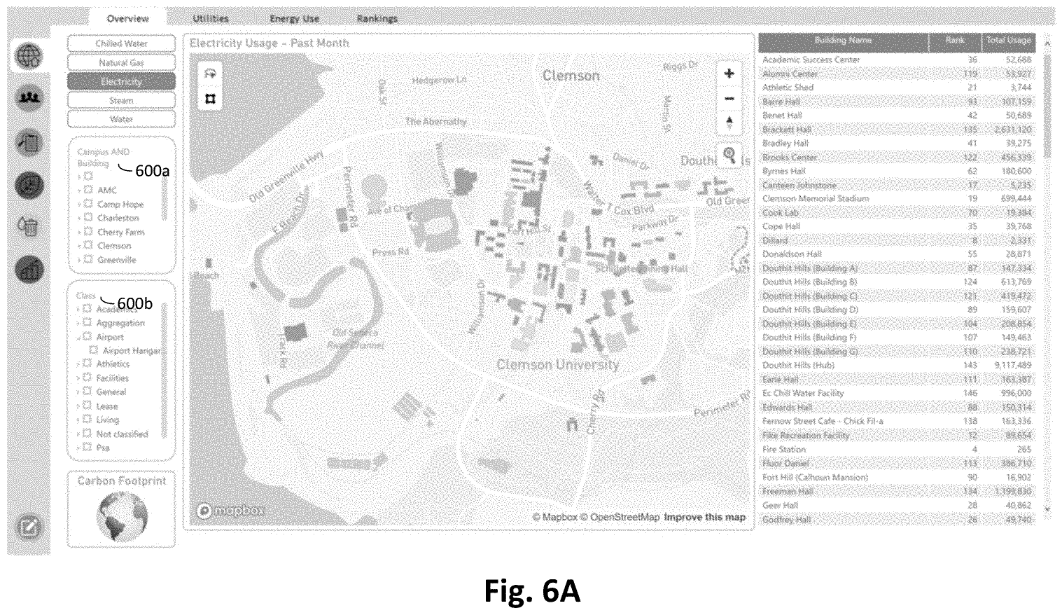

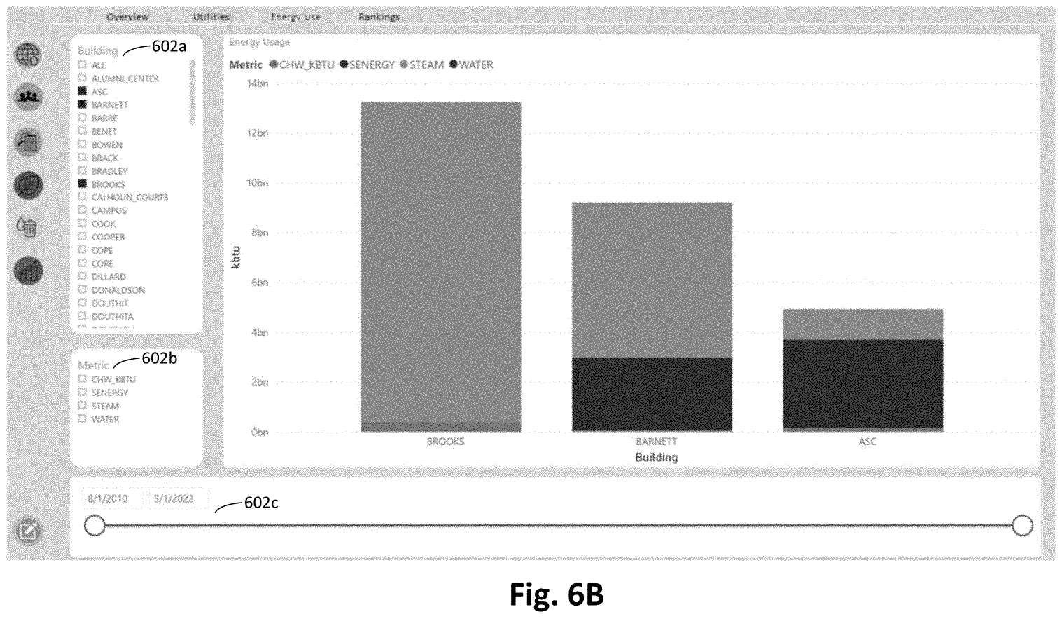

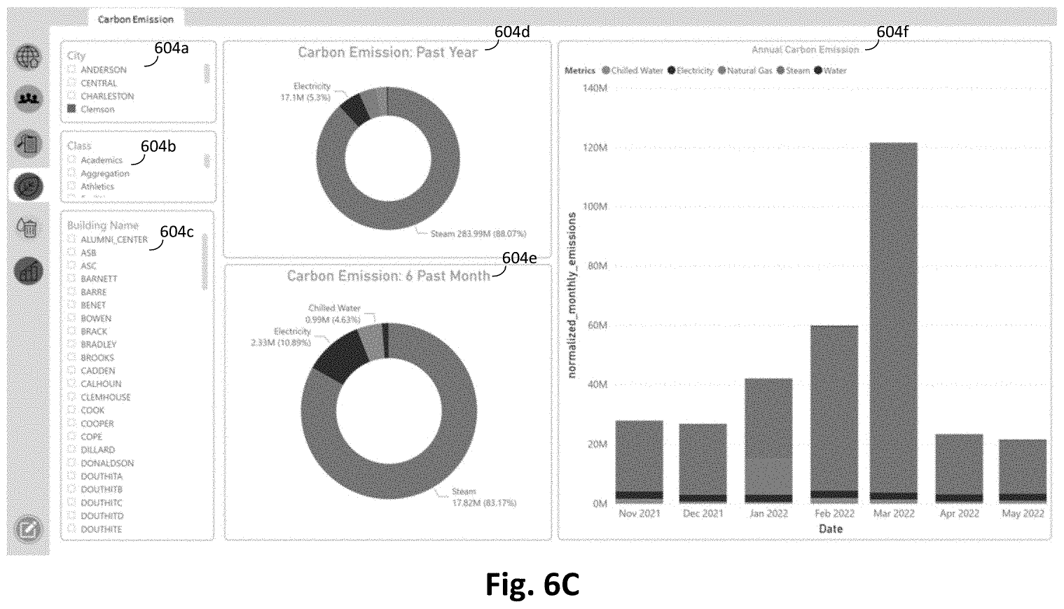

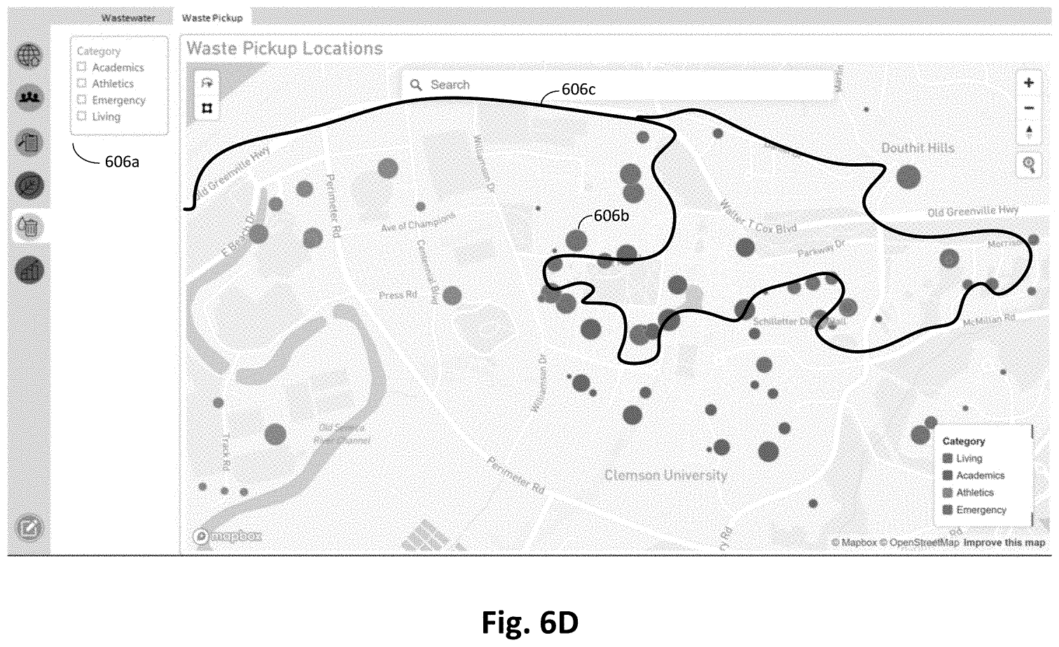

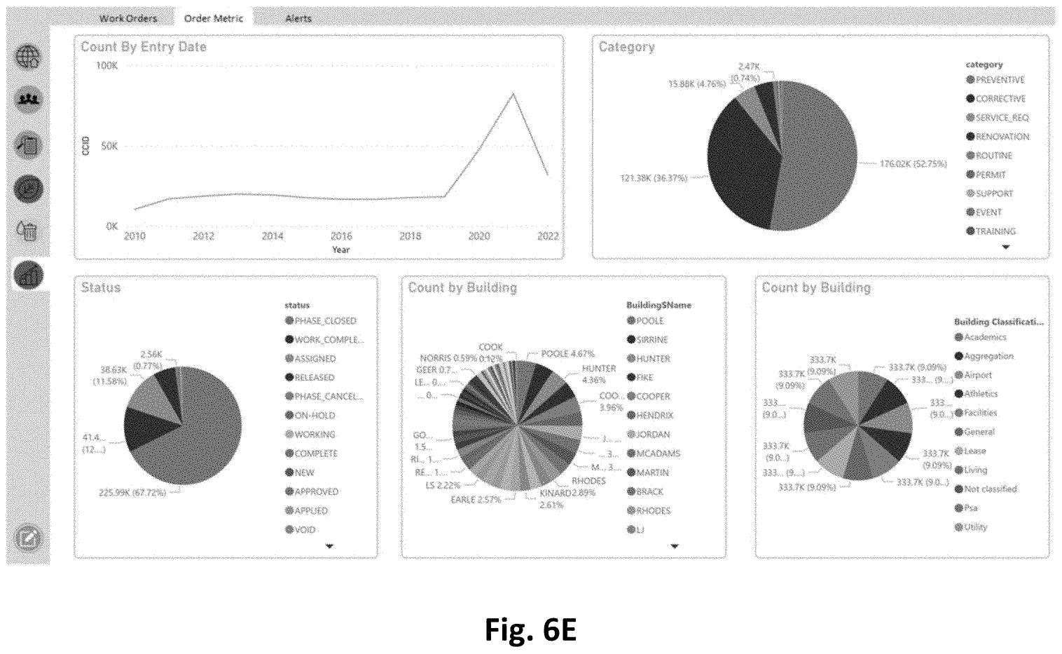

Referring to FIG. 6A, the system can receive, analyze, process, and use the data from various physical locations 600a as well as the classification of the building 600b, and their emission sources, to determine the emission of an enterprise (e.g., campus). The system can also review the energy use for each building as shown in FIG. 6B where the system allows for selection of the building and the emission source for each building. Each building 602a and emission source 602b can provide data that can be aggregated into one or more data pipes. The system can also provide for the time frame where data is used and reported as illustrated with 602c. Referring to FIG. 6C, emission for an enterprise can be shown for locations, 604a, classification 604b, building 604c, composition of contribution to emissions 604d and 604e and the aggregated emissions 604f. Referring to FIG. 6D, the system can receive, analyze, process, display and use information from remated emission sources and the corresponding system such as water removal. The data and therefore data pipe for this emission source can include the classification of the building where waster removal is preformed as shown as 606a, the location of the water removal activities 606b, the categories of building and areas where the waste removal activities are preformed and the path 606c between pickup locations. In one embodiment, the system can receive data from a waste removal third party that can include vehicle types, fuel types, routes, schedule, and disposition of the water once it is removed. This information can be used to determine the emissions that can be associated with the enterprise from not only direct emission sources, but also indirect emission sources. The system can analyze, process and provide proposed modifications to the third party to the vehicles used, disposition of waste, route and schedule and provide the impact on emission (direct and indirect) that would results were the proposed modification to be implemented. For example, if the waste removal vehicle were to be in operation on the enterprise two days and week and run 5 miles over 8 hours for the week, the system may that the total emission from this activity is XX ppm for the week. If the third party were to switch the vehicle from diesel to gasoline, the emission could drop to YY ppm per week. Therefore less emissions are created. The system can then calculate the energy impact of switching from diesel to gasoline so that the incremental cost or saving from making such as switch and the lowered emission can be determined. Further, the system can analyze the routes and can add waster removal locations to make route more efficient, reduce routes to reduce emissions while maintaining waste removal, consolidate waste removal locations and determine the emission and costing impact of these proposed activities. The system can transmit these proposed modifications to the third party or display them to the user. Referring to FIG. 6E, the system can also be used to manage maintenance for the facility. The system can track and report the status of various work orders.

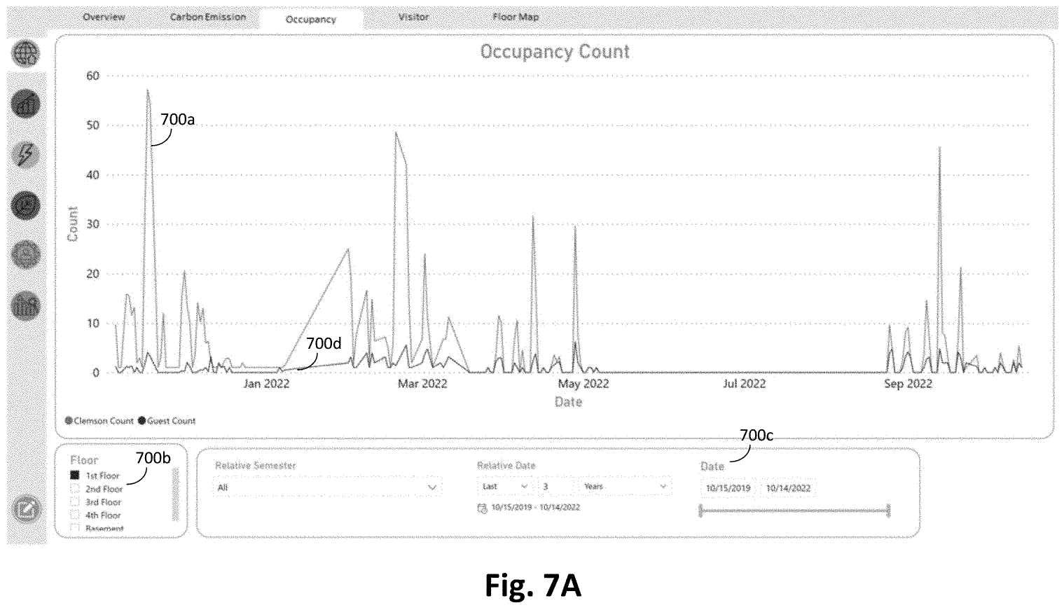

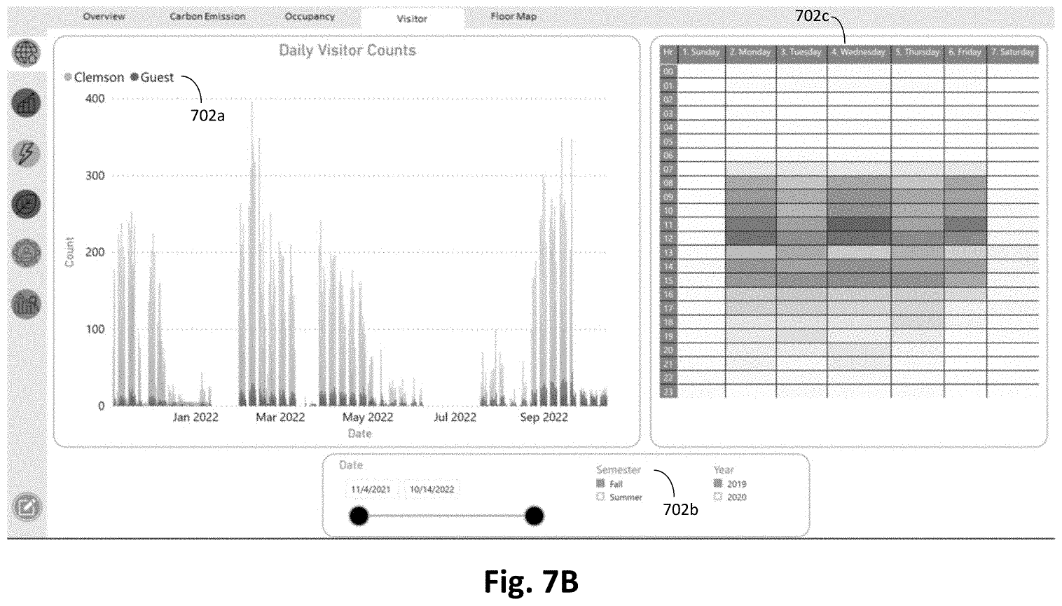

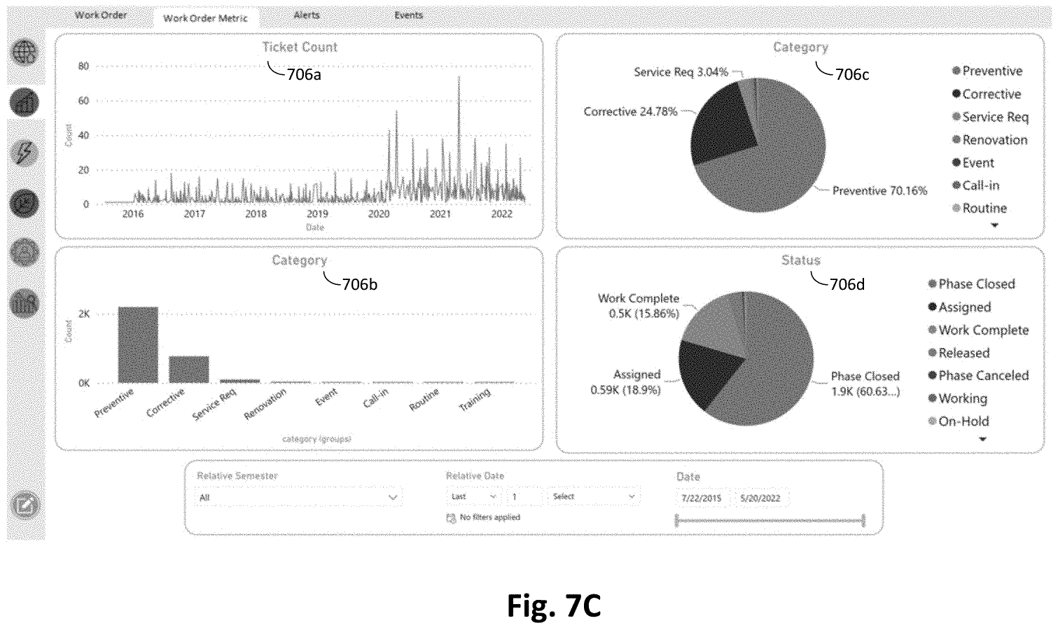

Referring to FIG. 7A, the system can determine the impact of air quality and emission from occupancy of facilities. Using sensors, the system can determine that an individual has passed through a door or is otherwise present in a room. Proximity sensors can be used as entryways to determine occupants entering and exiting the building so that the number of occupants in the building and a room can be determined. The system can also determine the number of computer devices that are connected to a wireless access point associated with the building and use that information to determine the number of occupants in the room as well as withing the range of the wireless access point. Therefore, the emissions from individuals can be known in and outside the building. The sensors can determine that there are I₁ in the building and the wireless access point can determine the number of individuals that are in proximity to the building. Therefore, the system can determine the number of individuals that are in proximity to the building I₂, but have not entered the building with I₂-I₁ reprsenting the number of individuals in proximity and outside the building. The occupancy count 700a can be shown graphically and can represent the emission from occupants in the building. This count can be translated into an emission. For example, the system can use the assumption that a single individual exhales 2.3 lbs. of CO₂ per day. The system can then determine the time that the occupant is in the building to determine the increase in emission due to occupancy. The activity that is being performed in the building can be used to increase the amount of CO₂ contribution of decrease the amount of CO₂ contribution. For example, if the occupant is engaged in physical activity, the amount of CO₂ emission will be increased while studying in a library, at rest, can decrease the contribution. The emission can be analyzed, processed, displayed and used for predictions and recommendation by floor 700b, period of time 700c and by occupant type such as line 700a representing students and line 700d representing faculty or staff.

Referring to FIG. 7B, the system can show occupancy by type at 702a and over time 702b. The system can also show in a scheduling format 702c and can overlay the emission information as received by the sensors with the occupancy so that the impact of occupancy with emission can be associated. The system can determine that at certain times during the schedule can lead to rising emission from occupancy and activities to even where the emission cause the air quality to become unacceptable (e.g., CO₂ rising to over 1000 ppm levels). For example, the system can determine that CO₂ levels reach unacceptably levels at 1200 hours on Monday and Wednesdays. The system can also determine that this rise in CO₂ level is due at least in part by the higher occupancy for these times. The system can analyze and calculate that if the occupancy were to be lower by XX percent during these times, the CO₂ levels would be at acceptable levels. The system can also determine that during 1300 that the CO₂ levels are at lower levels and suggest that classes schedule for 1200 (and even 1100) in this example, be moved to later in the day so that the CO₂ levels at any given period of time (e.g., a class) are within acceptable levels). The ability to analyze, display and provide predictive actions allows the overall emission to remain the same while the emission levels remain at acceptable levels throughout the day and activity. The ability to monitor, propose reduction, modify schedule system, send recommendations to schedule system and reduce overall concentration of occupants can impact not just CO₂ levels, but also other emissions including electromagnetic radiation. The more electronic devices in an area, the higher the electromagnetic radiation. As public and private activities (companies, universities and the like) rely on the use of electronic device, the concentration of these could lead to unacceptable levels of electromagnetic radiation. The system has the ability to determine and approximate the number of electrical devices in an area and calculate the resulting electromagnetic radiation, including in the aggregate, and provide recommendations and action to reduce the overall electromagnetic radiation. Data pipes related to portable computer devices can provide emission information which the system can use to analyze, process and provide actions and recommendations to minimize exposure. The wireless access point can determine that there are X number of type 1 phones in an area that have a specific absorption rate of 0.99 while there are Y phones of type 2 with a specific absorption rate of 1.17. Therefore, the aggregate specific absorption rate that can be associated with radiofrequency energy can be managed by this system.

Referring to FIG. 7C The system can also receive, analyze, process, and use for emission management the building health since building with operational and structure issues can lead to higher emission (e.g., heating or cooling not being as efficient and running longer). The system can receive directed or from a building management system the number of work orders that are associated with a building (e.g., tickets) which is shown as 706a. The activities that are presented by the work order can be categorized as shown as 706b. The contribution of each category can be shown as 706c and the status of the activity shown as 706d. The activity that is represented by the work order can be compared to the emission of the facility so that the impact of the work order activity and the status can be used to determine the impact of building heath on the emissions. For example, if a certain building has corrective activities that are associated with entryways and the heating or cooling of the building is using more energy for these systems while the work order is outstanding, the emission for improper entryways can be determined. A entryway that will not properly seal will lead to higher heating and cooling needs which can be associated with higher emissions. Therefore, the emission benefit of preventive maintenance and the emission costs of disrepair can be determined and used for display or recommendations. The system can also receive and report alerts from any one of the system herein, including the building management system, heating, cooling, water process, and the like. These alerts can be associated with a work order and the benefit or costs of emission for taken action or not taking action can be determined. For example, if a building access system detects that a door has been open for longer than a predetermined period of time (e.g., 30 minutes) the system can generate an alert. The system can then calculate the emission costs of an open door and provide the information that can be used to prioritize work orders.

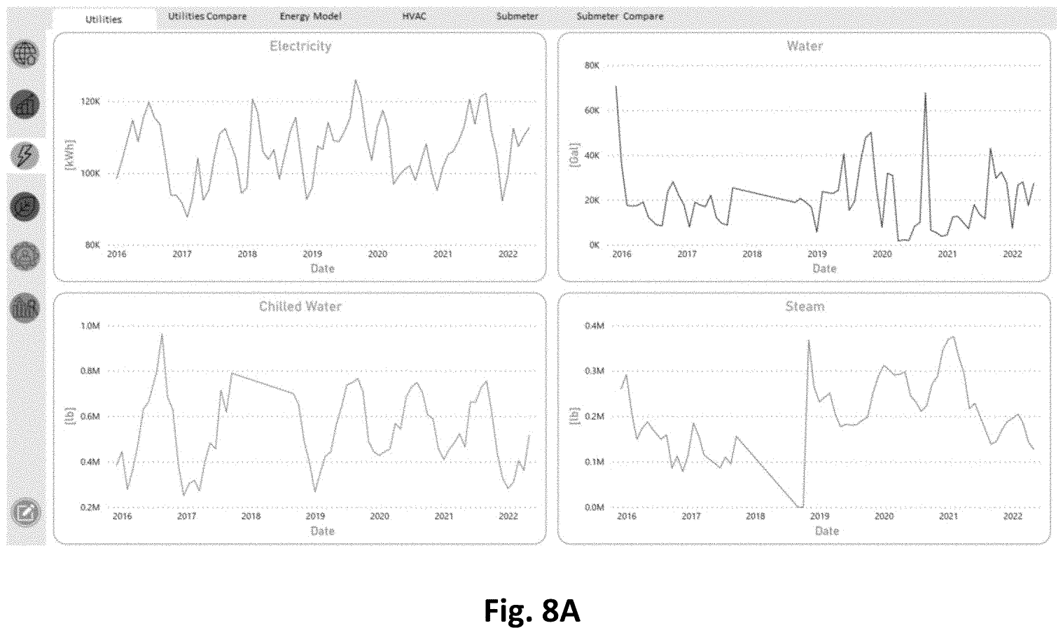

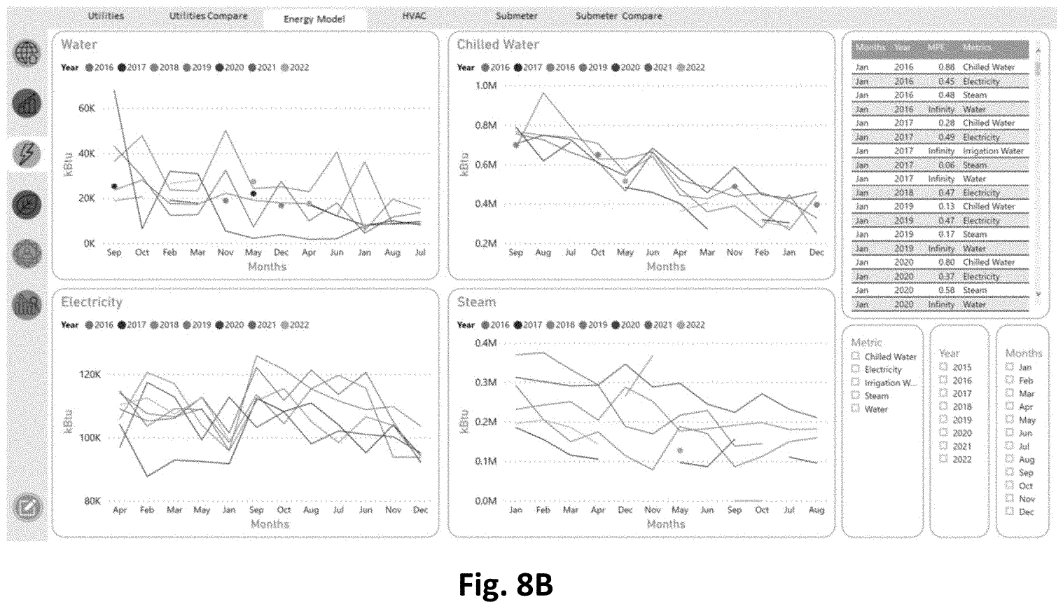

Referring to FIGS. 8A and 8B, the system can be used to report and predict resource usage of the enterprise for resource type and over a period of time. The resources can include utilities used, heating and cooling and any subsystem of the building or facilities utilities and equipment.

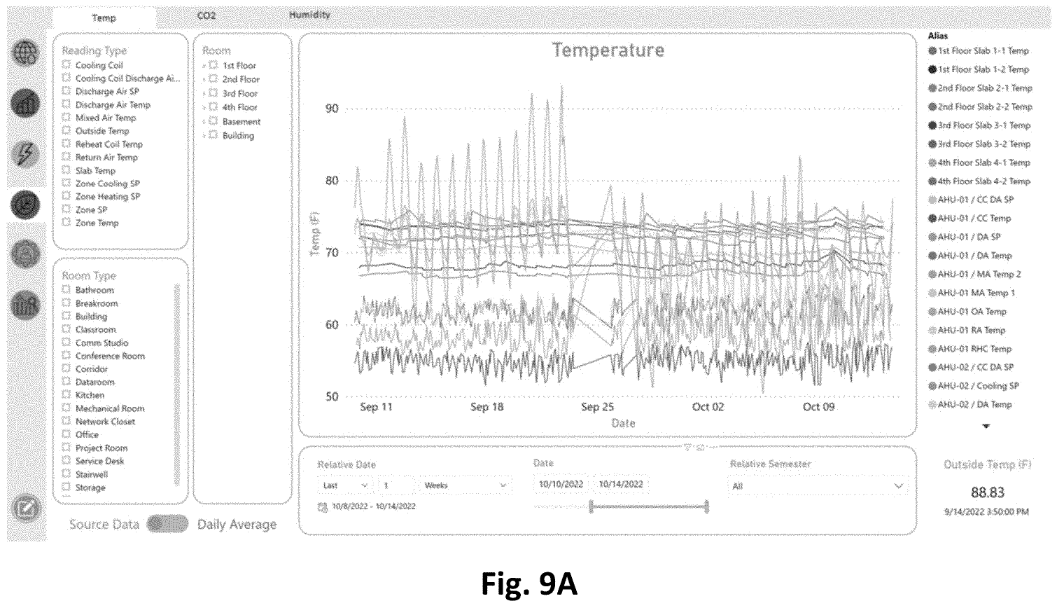

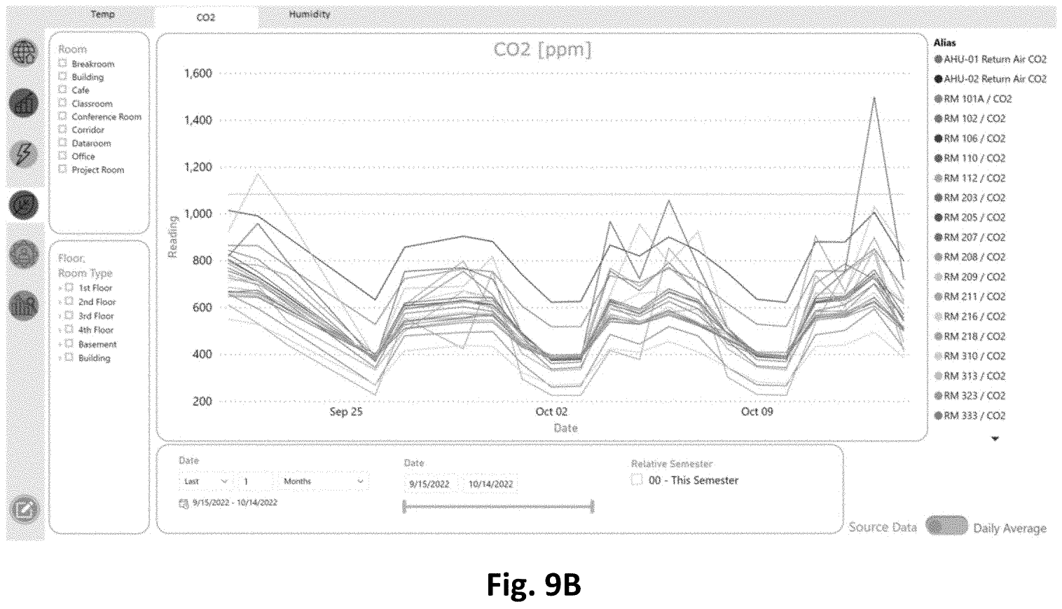

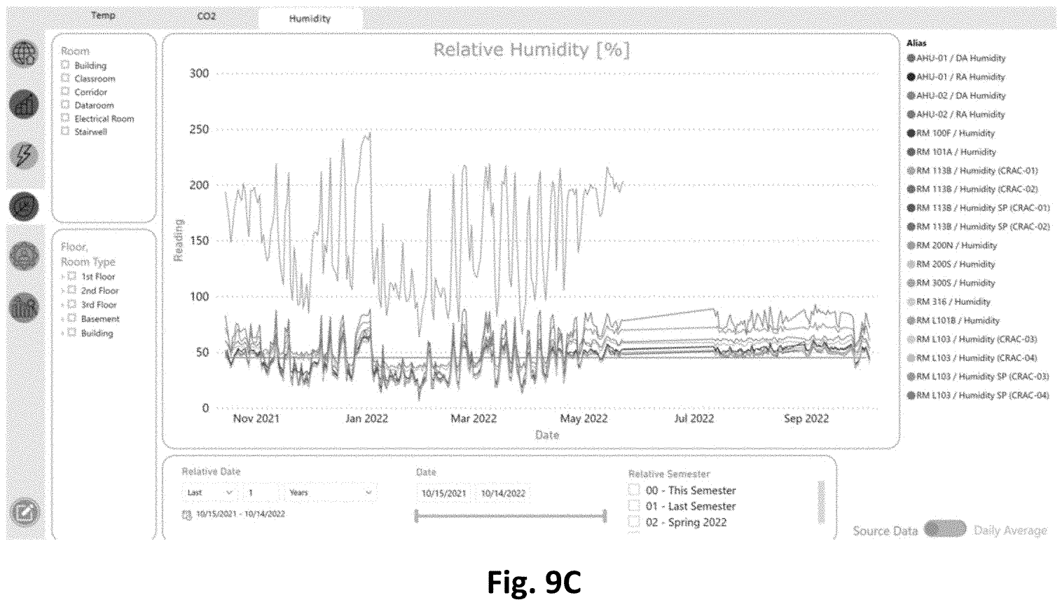

Referring to FIGS. 9A through 9C the indoor environment of a building can be represented with data that is received from sensors, building management systems, occupants, and calculated from the various data points and data pipes described here. These indoor environmental conditions can be displayed graphically and for a selected period of time. Further, the environmental conditions and the information from building systems can be correlated with the emissions so that the system can provide predictions concerning emission according to historical indoor environmental conditions. For example, if the outdoor weather is below 40 degrees and the indoor temperature is 70 degrees, the system can determine that a certain level of emission is associated with heating the building, which would be higher than were the outdoor temperature 65 degrees. Therefore, the emissions can be predicted according to the outdoor weather, as well as including occupancy, humidity, and other factors as described herein. This ability create a feedback loop using the various data layers so that the system can provide reporting, predictive information, generate actions that can be implemented or transmitted to other systems for implementation and then begin the process again.

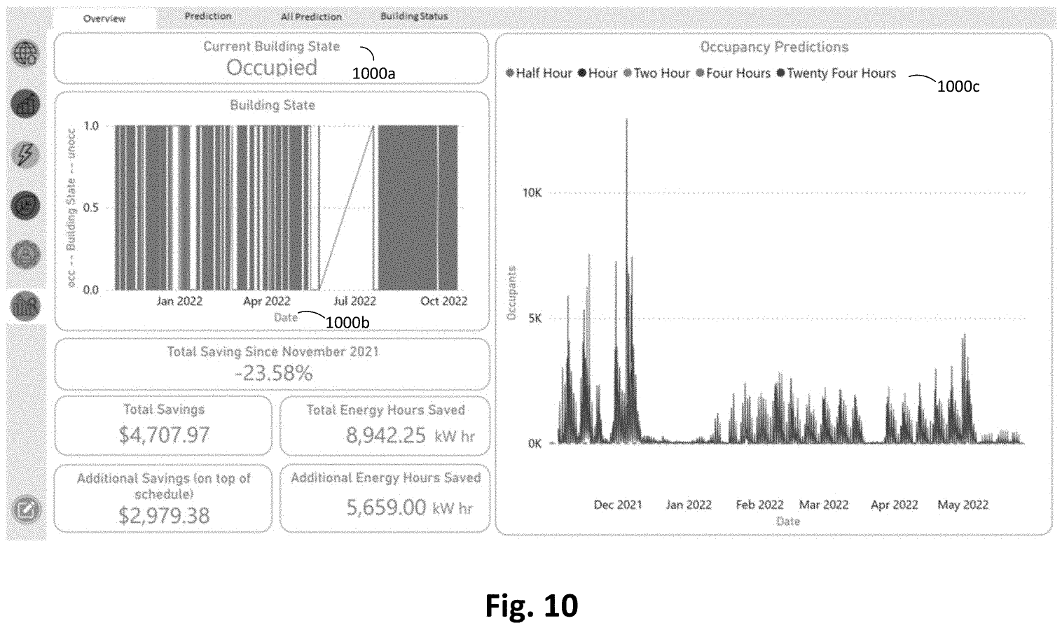

Referring to FIGS. 10, the occupancy can be determined and predicted so that the impact of occupancy on the emissions and emission sources by associating the occupancy with these emission sources can be used for predictive and the generation of actions. The building can report that its current state is occupied at 1000a. This information can be received, displayed, and used over a period 1000b. the system can use the historical information, schedule from s scheduling system, work orders and other information to predict the occupancy that is shown at 1000c. The predictions concerning occupancy can be used to anticipate power usage as well. From this information the infrastructure for the building can be controlled in a more proactive manner than the traditional reactional methods of adjustments according to existing factors, not anticipated factors. In one embodiment, computer readable instructions for machine learning are implemented to provide the functionality described herein. The predictive occupancy was compared with actual occupancy so that the computer readable instructions would adjust the determination of the occupancy for a given period of time. The actual emission and the predictive emissions can also be used for machine learning so that the system continues to provide feedback from actual and anticipated emissions, the system can assign difference values to anticipated associates. For example when a sensor determines that the CO₂ emission are E₁ and the predictive information shows E₂, the system can adjust the emission associated with the relevant activity to more closely reflect the actual recorded values. For example, in a building where athletic activity is performed, the system can have an assigned CO₂ emission value for each individual at 2.3 lbs. of CO₂ per day and use twice that for physical activity. The system, when comparing the actual to the predictive emission, could determine that the emission for the physical activity were one and one half times the normal emission and adjust the allocation (e.g., creation of CO₂ per day) downward.

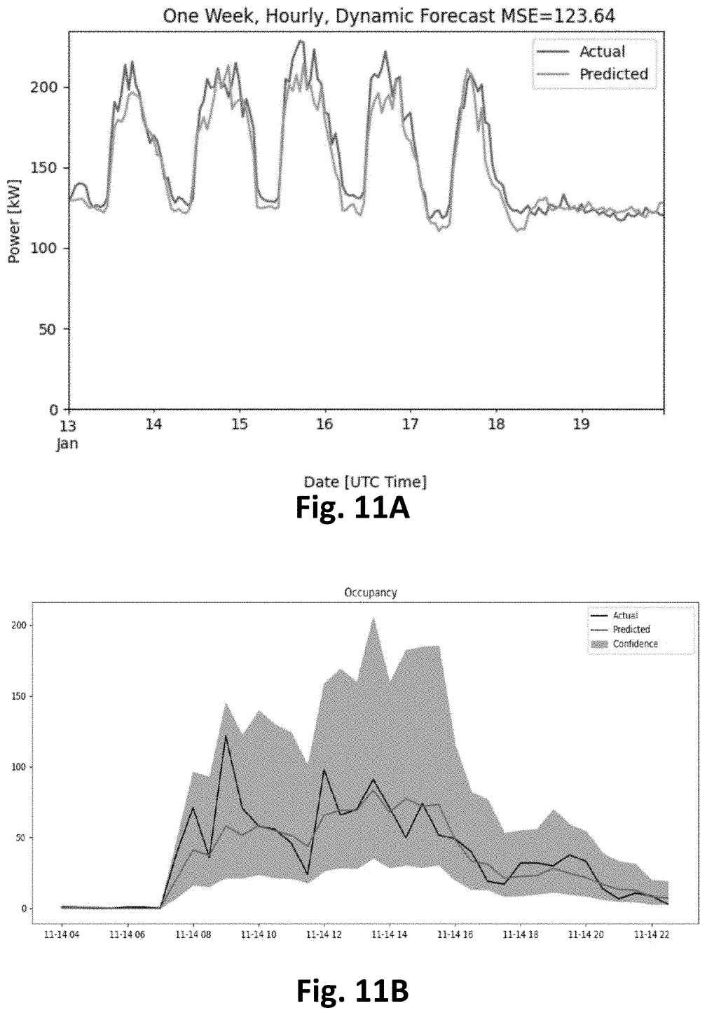

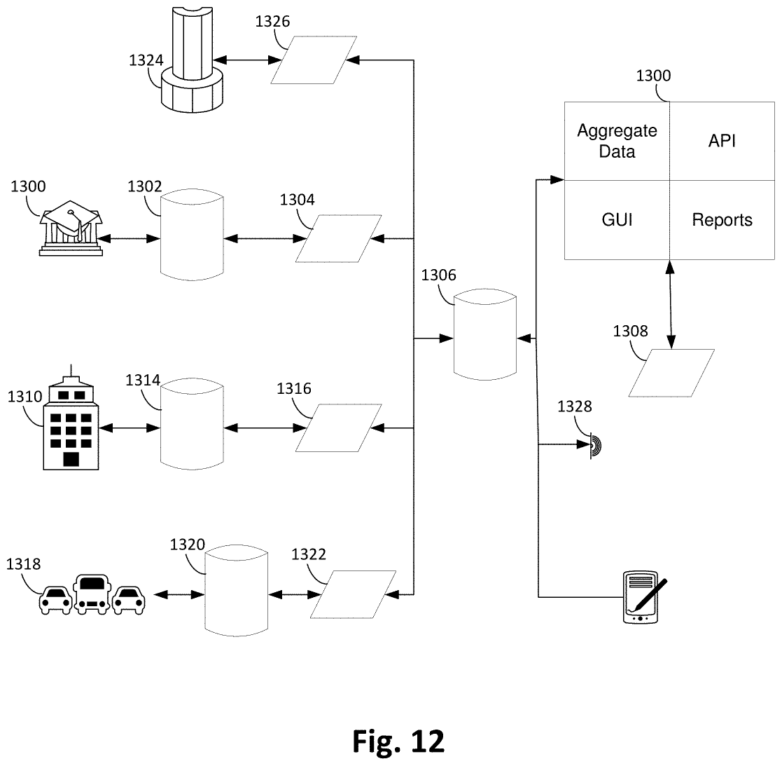

Referring to FIG. 11A and 11B, the system can compare the actual and the predicted power consumption (and therefore emissions) and as shown the predictive nature of the system is quite accurate. Further, the system can include a confidence associated with the ability to predict various value that is shown in FIG. 11B. The closer the predictions are to the actual recorded data pips information, the higher the confidence values. The system can use the confidence values to be associated with predictions and generate proposed actions so that the actions are implemented, transmitted or suggested with the confidence values known.

The predictive model of the present system can include determinations from wireless access points which can be used for a determination of occupancy as well as the type of occupant (e.g., guest, student, facility, employee, etc.), schedules, calendars and other data sources that can be enterprise and institutional. The analytics computer readable instructions can include the ability to retrieve and use information from predictive models such as weather models, existing and historical system data from the present system, and historical building data. The system can determine heat gain, internal temperature, moisture, occupancy, and other factors that can result in the sin use of power, heating, cooling and power consumption.

The system can also determine emission for events. For example, an athletic event for a league can have over 80,000 occupants for an athletic game. This can account for a large number of emissions which can be calculated by the system from transportation, attendees, food, cooking, electrical generation (e.g., generators) and the like.

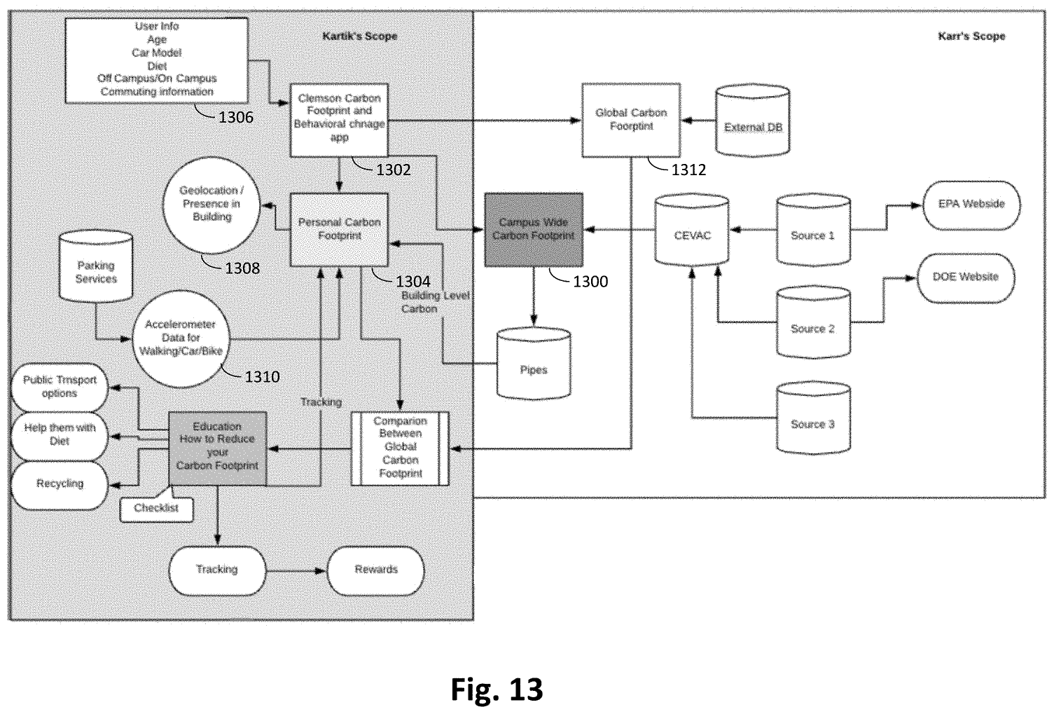

Referring to FIG. 13, the system can be used for management and analysis as well as assessments of existing areas, buildings, and enterprises. A building 1300 can be one of many in an enterprise. The building can include access controls, power, equipment, heating, cooling, air handling, and the like, each with one or more data sources and data pipes. For example, wireless access points can feed data into a database 1302 that can have data associated with that building. The database can be a single database or can be a table in a larger database. The data can be in a format that is determined by the vendor of the wireless access point. The data can be converted or normalized into a dataset that can be used by the system through a normalization component 1304 which can be hardware and software with specific computer readable instructions associated with that data source. For example, if a wireless access point provides a DCHP acknowledgement, the data from the wireless access point can be converted to a digital representation that an occupancy is in proximity of that wireless access point and increate the occupancy account by one.

Data can be fed into a centralized database 1306. The database or dataset can then be retrieved, analyzed, and processed by system 1300. The system can include computer readable instructions that can provide data analysis, digital representations of the enterprise, graphical representations of the data received, aggregate data, provide predictive analysis, provide application data interface for third parties, graphical user interfaces, reports, and transmit the data to local or response systems. The results from the system can be exported or otherwise made available to third parties through an export set of counter readable instructions 1308. Other data sources can include other buildings or facilities 1310 which can have a dataset of database 1314 can be converted or normalized with computer readable instructions 1316, vehicles and transportation systems 1318 which can have a dataset or database 1320 and can be normalized with computer readable instructions 1322. Third-party systems 1324 such as actual or predictive weather systems, energy types, energy usage, and the like can be received by the system and can be normalized with computer readable instructions 1326. The server can be in communication with various sensors 1328 that are disposed in or around a building or enterprise and can be aggregated into a sensor data pipe that can be received by a set of computer readable instructions. The system can also receive information from individual devices that can provide preferences and behavior to occupants and others associated with the building and enterprise.

Referring to FIG. 13, one embodiment of the system can be shown in further detail. System 1300 can receive information from a user application (user app) and computer device 1302. The user app can be used to determine a personal emission footprint (e.g., carbon footprint) 1304 for that user. The user app can include information about the user such as user vehicle information 1306. The position on an enterprise se(e.g., campus) can be determined from geolocation from the user app at 1308. The activity of the user can be determined at 1310 and the emissions associated with the activity determined. For example, walking will have a lower emission value than running and running a lower emission value than driving a fuel powered vehicle. The user app can also provide suggestions for the reduction of the emission. These suggestions can be provided from the user app computer readable instructions which perform analysis, predictions and recommendations as well as the server analysis, predictions and recommendations or a combination of the two. The user can also provide information such hash the food consumed or even the preferred food consumed which can be used by the server and its computer readable instructions for making predictions and recommendations. For example, if a recommendation include the eliminations of beef-based meals, and the user preference is for beef-based meals, the server can alter the recommendations to reduce, rather than eliminate, the beef-based meals. The user can also use the app to provide for user preferences concerning the enterprise such as temperature. The user can provide preferences for the environment such as the temperature that is comfortable for the user of the remote application. This information can be included in the determination of action or recommendations. For example, if the system determines that a saving can be realized were the temperature of the building or room be reduced to 68 decrees from 72 degrees in the winter for lowering emissions and power costs, the system can compare this to the user app information for occupant preferences. Based upon the user application information, the system can determine that lower the temperature is less than a preferred temperature expressed by a number of users. The decision to lower the temperature or the degree to which to lower the temperature can be modified in this case. The user app can also contribute to the global emission of the enterprise at 1312.

The user app can also provide information to the user of the user app concerning the emission that are attributable to the user and the user behavior. For example the user app can include emission and remediation associated with the user for building user, commuting, recycling and the like. The user app can provide information based upon the behavior of the user and can provide recommendations for modifications to behavior and action to reduce emission and even provide credit to the user as a reward that can be exchanged as if flat currency. The areas in which the user app can determine emission and provide recommendations to changes can include the activities and the behavior of the user in relation to the behavior and actions associated with land use (e.g., dorm or apartment), farm and animal feed (e.g., type of food consumed), processing (e.g., food and material used), transportation (e.g., vehicle type, fuel type, distance, activity), retail (e.g., goods and services, building use, shipping, processing, manufacturing), packaging (e.g., type of packing use) and any combination. For example, if the user is presented with information showing the emission associated with beef consumption, the user could reduce or eliminate beef from the user's diet. In this case, the user can be provided credits for the change in behavior.

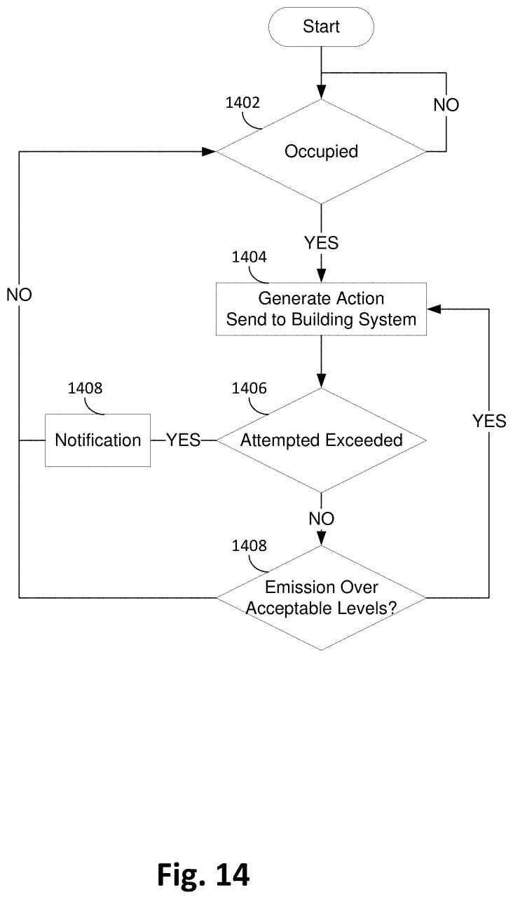

Referring to FIG. 14, an example of building actions that can be sent to or recommended to a building system is shown. In one embodiment the system can determine if the building is occupied from several sources including building access systems, sensors, wireless access points, schedule systems and occupancy models. If the determination at 1402 is made that the building is not occupied, the system can verify that the building is in unoccupied mode (e.g., system are turned down such as lower the temperature or even turned off). If the building is in unoccupied mode and systems are operational as if the building is occupied, the building management system can be provided with an action to recommend that the building systems convert to unoccupied mode. When the building is occupied, the system can generate an action such as informing a user that the building is occupied, changing the status of the building to occupied, generating an action to turn on or up building systems and the like at 1404. If the action attempts are unsuccessful for a predetermined period of time at 1406, the system can send a notification that the action or recommendation was not implemented and create a notification that can be transmitted to a user or system at 1408. If the number of attempts has not exceeded a predetermined level and the indoor environment (e.g., emission levels) are not lowered below the acceptable level at 1410, the process can return to 1404.

It is understood that the above descriptions and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

Those skilled in the art will understand that the screens of the system provided wherein can be produced and created using computer readable instructions. Further those skilled in the art will understand that the information and data that is shown in the screens of the system represent data, data pipes, calculation that are actions on data representing physical events and objects, and that the system can manipulate these physical representations so that the system impacts the physical world in a manner not previously seen in the industry.

What is claimed is:

1. A system for actuating a facilities management system comprising:
a server having a computer readable medium;
a direct data pipe in communication with the server and a first emission source wherein the direct data pipe is configured to receive a first emission information from the first emission source representing a direct emission attributable to a facility;
an indirect data pipe in communication with the server and a second emission source wherein the indirect data pipe is configured to receive a second emission information from the second emission source representing an indirect emission from a remote source;
a remediation data pipe in communication with the server and a remediation source wherein the remediation data pipe is configured to receive a remediation information from the remediation source;
a sensor in communications with the server;
a facilities system in communication with the server; and,
a set of computer readable instructions stored on the computer readable medium and configured to:
receive the first emission information, the second emission information, and the remediation information,
calculate an indirect emission value according to the second emission information and a remote source type,
calculate an occupancy emission according to the sensor,
calculate an enterprise emission value according to the first emission information, the indirect emission value, the occupancy emission and the remediation information,
generate a facility action information according to a comparison of the enterprise emission value and a target emission value, and,
transmit the facility action information to the facilities system wherein the facilities is configured to implement or reject an action represented by the facility action information.

2. The system of claim 1 wherein the set of computer readable instructions are configured to:
store the enterprise emission value on the computer readable medium defining a historical emission data set,
receive a scheduling information from a scheduling system representing anticipated occupancy of the facility,
generate an anticipatory action according to the historical emission data set and the scheduling information, and,
transmitting the anticipatory action to the facilities system.

3. The system of claim 1 wherein the set of computer readable instructions are configured to calculate the indirect emission value according to a remote source fuel type.

4. The system of claim 3 wherein the set of computer readable instructions are configured to generate the facility action information according to the remote source fuel type.

5. The system of claim 4 wherein the remote source fuel type is taken from the group consisting of natural gas, coal, nuclear, biomass, petroleum, geothermal, solar, wind, hydropower and any combination thereof.

6. The system of claim 1 wherein the target emission value is 1000 ppm CO₂ or less.

7. The system of claim 6 wherein the facility action information includes actuating an air handler included in the facilities system for transferring a higher concentration of CO₂ air mass to a lower concentration of CO₂ air mass.

8. The system of claim 1 wherein the set of computer readable instructions are configured to generate a remediation action information according to a comparison of the enterprise emission value and the target emission value and transmit the remediation action information to a remediation system in communication with the server.

9. The system of claim 8 wherein the remediation action information includes actuating the remediation system until a requested CO₂ level is achieved.

10. The system of claim 1 wherein the set of computer readable instructions are configured to display a future emission value according to a set of enterprise emission values determined over a period of time.

11. The system of claim 10 wherein the set of computer readable instructions are configured to generate a future facility action information according to the future emission value.

12. The system of claim 1 wherein the second emission source is taken from the group consisting of stationary fuel, indirect transportation, fertilizer, animals, paper purchased, food and any combination thereof.

13. A system for actuating a facilities management system comprising:
a server having a computer readable medium;
a direct data pipe in communication with the server and a first emission source wherein the direct data pipe is configured to receive a first emission information from the first emission source representing a direct emission attributable to a facility;
an indirect data pipe in communication with the server and a second emission source wherein the indirect data pipe is configured to receive a second emission information from the second emission source representing an indirect emission from a remote source;
an occupancy sensor in communications with the server configured to determine an occupancy of a portion of the facility;
a facilities system in communication with the server; and,
a set of computer readable instructions stored on the computer readable medium and configured to:
receive the first emission information and the second emission information,
calculate an indirect emission value according to the second emission information,
calculate an occupancy emission according to the occupancy sensor,
calculate an enterprise emission value according to the first emission information, the indirect emission value, and the occupancy emission,
generate a facility action information according to a comparison of the enterprise emission value and a target emission value, and,
transmit the facility action information to the facilities system.

14. The system of claim 13 including an air quality sensor in communication with the server configured to determine an air quality within the facility and the set of computer readable instructions are configured to calculate the enterprise emission value according to the air quality.

15. The system of claim 13 wherein set of computer readable instructions area configured to generate a remediation action information according to the comparison of the enterprise emission value and the target emission value and transmit the remediation action information to a remediation system.

16. The system of claim 15 wherein the remediation system is a direct air capture system.

17. The system of claim 13 wherein the occupancy sensor is a wireless access point.

18. The system of claim 13 wherein the occupancy sensor is included in an access control system.

19. A system for actuating a facilities management system comprising:
a server having a computer readable medium;
a direct data pipe in communication with the server and a first emission source wherein the direct data pipe is configured to receive a first emission information from the first emission source representing a direct emission attributable to a facility;
an indirect data pipe in communication with the server and a second emission source wherein the indirect data pipe is configured to receive a second emission information from the second emission source representing an indirect emission from a remote source;
a scheduling system in communications with the server and configured to manage an assignment of individuals to the facility;
a facilities system in communication with the server; and,
a set of computer readable instructions stored on the computer readable medium and configured to:
receive the first emission information and the second emission information,
calculate an indirect emission value according to the second emission information,
calculate an occupancy emission according to the assignment of individuals to the facility,
calculate an enterprise emission value according to the first emission information, the indirect emission value, and the occupancy emission,
generate a facility action information according to a comparison of the enterprise emission value and a target emission value, and,
transmit the facility action information to the facilities system.

20. The system of claim 19 wherein the set of computer readable instructions are configured to generate a modification to the assignment of individuals to the facility, calculate a modified occupancy emission according to the modification to the assignment of individuals to the facility, calculate a modified enterprise emission value according to the occupancy emission and transmit the modification to the assignment of individuals to the facility to a scheduling system according to a determination that the enterprise emission value is higher than the modified enterprise emission value.

21. The system of claim 19 wherein the enterprise emission value is a CO₂ level.

22. The system of claim 19 wherein the second emission source is taken from the group consisting of a vehicle, an occupant age, an occupant diet, an occupant housing, weather, and any combination thereof.

23. The system of claim 19 including a remediation data pipe in communication with the server and a remediation source wherein the remediation data pipe is configured to receive a remediation information from the remediation source and the set of computer readable instructions are configured to generate a remediation action information according to a comparison of the enterprise emission value and the target emission value and transmit the remediation action information to a remediation system associated with the remediation source.

24. The system of claim 19 including a remediation data pipe in communication with the server and a remediation source wherein the remediation data pipe is configured to receive a remediation information from the remediation source and the set of computer readable instructions are configured to generate the enterprise emission value according to the remediation information.

25. The system of claim 24 wherein the remediation source includes vegetation.

26. The system of claim 19 wherein the first emission source is taken from the group consisting of a chilled water system, a natural gas system, a electricity system, a steam system, a water system, a waste management system and any combination thereof.

27. The system of claim 19 wherein the first emission information and the second emission information are CO₂ emission.

28. A system for actuating a facilities management system comprising:
a server having a computer readable medium;
a direct data pipe in communication with the server and a first emission source wherein the direct data pipe is configured to receive a first emission information from the first emission source representing a direct emission attributable to a facility;
an indirect data pipe in communication with the server and a second emission source wherein the indirect data pipe is configured to receive a second emission information from the second emission source representing an indirect emission from a remote source;
a facilities system in communications with the server; and,
a set of computer readable instructions stored on the computer readable medium and configured to:
receive the first emission information and the second emission information,
calculate an indirect emission value according to the second emission information,
calculate a current enterprise emission value according to the first emission information and the indirect emission value,
retrieve a set of historical emission values from the computer readable medium,
calculate a predictive emission value according to the current enterprise emission value and the set of historical emission values.

29. The system of claim 28 wherein the set of computer readable instructions are configured to generate a facility action information according to a comparison of the predictive emission value and a target emission value.

30. The system of claim 28 wherein:
the predictive emission value is a first predictive value representing emission associated with the facility, and
the set of computer readable instructions are configured to:
generate a confidence level according to a comparison of the current enterprise emission value with the predictive emission value, and
calculate a second predictive emission value according to the current enterprise emission value, the set of historical emission values and the confidence level.
